(19) United States
(12) Patent Application Publication
(10) Pub. No.: US 2024/0369961 A1
(43) Pub. Date: Nov. 7, 2024

(54) STATIC ELIMINATION DEVICE AND IMAGE FORMING DEVICE

(71) Applicant: FUJIFILM Business Innovation Corp., Tokyo (JP)

(72) Inventors: Hirotaka TANAKA, Kanagawa (JP); Tomokazu KURITA, Kanagawa (JP); Satoshi SHIGEZAKI, Kanagawa (JP); Koichiro YUASA, Kanagawa (JP); Jun KUWABARA, Kanagawa (JP); Katsumi TANAKA, Kanagawa (JP)

(73) Assignee: FUJIFILM Business Innovation Corp., Tokyo (JP)

(21) Appl. No.: 18/512,059

(22) Filed: Nov. 17, 2023

(30) Foreign Application Priority Data
May 2, 2023 (JP) 2023-076343

(51) Int. Cl. G03G 21/06; B65H 29/12; G03G 15/00; G03G 15/16

(52) U.S. Cl. CPC G03G 21/06; B65H 29/125; G03G 15/163; G03G 15/80; B65H 2301/5133

(57) ABSTRACT

A static elimination device includes: a pair of static elimination rollers that performs static elimination by allowing passage of a sheet-like material to be sandwiched between the pair of static elimination rollers; and a power supply unit that supplies a voltage for static elimination to at least one static elimination roller of the pair of static elimination rollers, wherein the pair of static elimination rollers is a pair of static elimination rollers in which contact pressures at ends in an axial direction are lower than a contact pressure at a portion other than the ends.

### CROSS-REFERENCE TO RELATED APPLICATIONS

This application is based on and claims priority under 35 USC 119 from Japanese Patent Application No. 2023-076343 filed May 2, 2023.

### BACKGROUND

### (i) Technical Field

The present invention relates to a static elimination device and an image forming device.

### (ii) Related Art

JP2022-161567A listed below describes a static elimination device including two static elimination rollers to which voltages of different potentials are applied and which perform static elimination by reducing a charge amount of a recording medium when the recording medium passes therebetween, and a peeling member which is provided to abut on a surface of one static elimination roller of the two static elimination rollers and adheres to the static elimination roller to peel the recording medium as the static elimination roller rotates.

JP2021-111526A listed below describes a static elimination device including a first static elimination member that makes contact with a medium that is transported, a second static elimination member arranged such that the medium is inserted between the first static elimination member and the second static elimination member, and a power source that applies a voltage to at least one of the first static elimination member or the second static elimination member, in which at least one of the first static elimination member and the second static elimination member has an elastic body.

JP2013-220871A listed below describes a label printer including a print head that performs printing on a label temporarily attached to a paper strip, a platen roller that feeds the paper strip that has passed through the print head in a first direction, and a removal unit that peels off the label from the paper strip.

In addition, JP2013-220871A describes that the removal unit includes: a removal roller which feeds the paper strip in a second direction, different from the first direction, while sandwiching the paper strip between the platen roller and the removal roller, and peels off the label from the paper strip to issue the label; a removal roller supporting portion including a rotation shaft which rotatably supports the removal roller; and auxiliary rollers which are provided on both sides of the removal roller in a direction of the rotation shaft and are rotatably supported on the rotation shaft.

### SUMMARY

Aspects of non-limiting embodiments of the present disclosure relate to a static elimination device or the like that performs static elimination by allowing passage of a sheet-like material to be sandwiched therebetween, the static elimination device or the like preventing adhesive components of an adhesive layer protruding from both ends of a sheet-like material from adhering to the pair of static elimination rollers even when the sheet-like material having the adhesive layer between layers is allowed to pass as the sheet-like material as compared with a case where the pair of static elimination rollers coming into contact with each other over the entire area in a width direction of the sheet-like material are in contact with each other at a constant contact pressure.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a static elimination device comprising: a pair of static elimination rollers that performs static elimination by allowing passage of a sheet-like material to be sandwiched between the pair of static elimination rollers; and a power supply unit that supplies a voltage for static elimination to at least one static elimination roller of the pair of static elimination rollers, the pair of static elimination rollers being a pair of static elimination rollers in which contact pressures at ends in an axial direction are lower than a contact pressure at a portion other than the ends.

### BRIEF DESCRIPTION OF THE DRAWINGS

FIG. 1A is a conceptual diagram of a whole of a static elimination device according to a first embodiment, and FIG. 1B is a conceptual diagram of a pair of static elimination rollers which is a part of the static elimination device of FIG. 1A.

FIG. 2A is a schematic cross-sectional view taken along line Q1-Q1 in the static elimination rollers of FIG. 1B, and FIG. 2B is a schematic cross-sectional view of a sheet-like material.

FIG. 3 illustrates an operation state of the static elimination device of FIGS. 1A and 1B.

FIG. 4A is a conceptual diagram of Modification 1 of the pair of static elimination rollers in the static elimination device of FIGS. 1A and 1B, and FIG. 4B is a conceptual diagram of Modification 2 of the pair of static elimination rollers in the static elimination device of FIGS. 1A and 1B.

FIG. 5A is a conceptual diagram of a whole of a static elimination device according to a second embodiment, and FIG. 5B is a conceptual diagram of a pair of static elimination rollers which is a part of the static elimination device of FIG. 5A.

FIG. 6 is an explanatory diagram illustrating an operation state of the static elimination device of FIGS. 5A and 5B.

FIG. 7A is a conceptual diagram of Modification 3 of the pair of static elimination rollers in the static elimination device of FIGS. 5A and 5B; and FIG. 7B is a conceptual diagram of Modification 4 of the pair of static elimination rollers in the static elimination device of FIGS. 5A and 5B.

FIG. 8A is a conceptual diagram of a whole of a static elimination device according to a third embodiment; and FIG. 8B is a conceptual diagram of a pair of static elimination rollers which is a part of the static elimination device of FIG. 8A.

FIG. 9 is an explanatory diagram illustrating an operation state in one mode of the static elimination device illustrated in FIGS. 8A and 8B.

FIG. 10 is an explanatory diagram illustrating an operation state in another mode of the static elimination device illustrated in FIGS. 8A and 8B.

FIG. 11 is a conceptual diagram of an image forming device provided with a static elimination device according to a fourth embodiment.

FIG. 12 is a conceptual diagram of an image forming section in the image forming device of FIG. 11.

FIG. 13A is a conceptual diagram of a modification of the image forming section of FIG. 12, and FIG. 13B is an explanatory diagram illustrating a relation between the image forming section of FIG. 13A and the static elimination device.

FIG. 14A is a conceptual diagram illustrating one operation state of a static elimination device according to a fifth embodiment; and FIG. 14B is a conceptual diagram illustrating another operation state of the static elimination device of FIG. 14A.

FIG. 15A is a conceptual diagram illustrating one operation state of a static elimination device according to a sixth embodiment; and FIG. 15B is a conceptual diagram illustrating another operation state of the static elimination device of FIG. 15A.

FIG. 16 is a conceptual diagram illustrating one operation state of a static elimination device according to a seventh embodiment.

FIG. 17 is an explanatory diagram illustrating a pair of static elimination rollers and a state of a static elimination operation thereof in a comparative static elimination device.

### DETAILED DESCRIPTION

Hereinafter, modes for carrying out the present invention will be described.

### First Embodiment

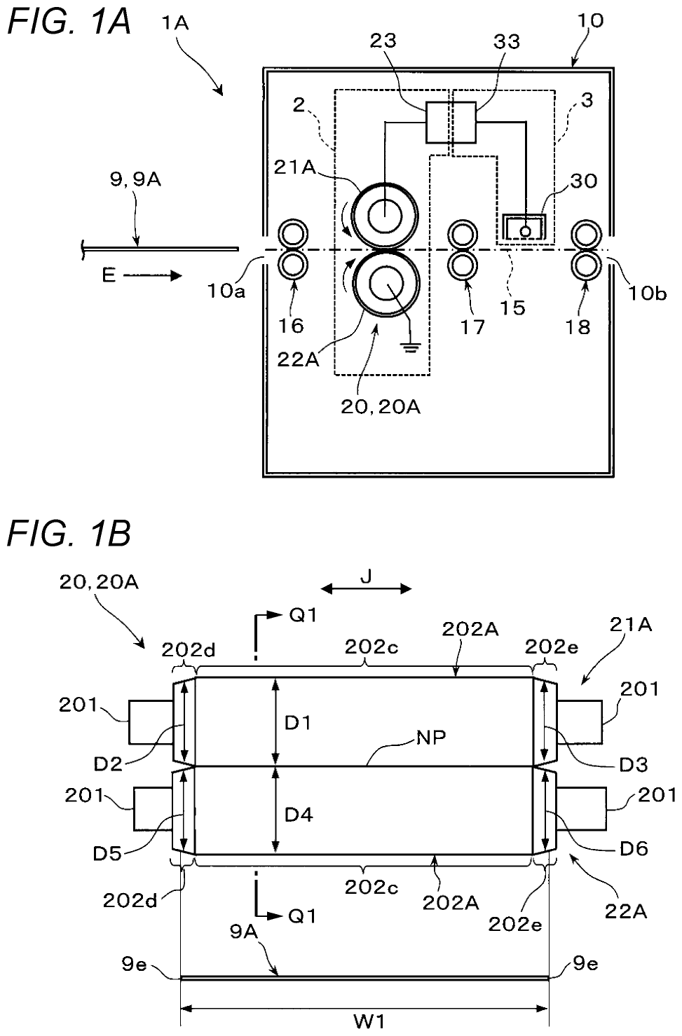

FIGS. 1A and 1B are conceptual diagrams illustrating a whole and a part of a static elimination device 1A according to a first embodiment of the present invention.

Substantially the same components will be denoted by the same references in the specification and the drawings, and redundant description of the same constituent elements will be omitted in the specification.

### (1-1) Basic Configuration of Static Elimination Device

The static elimination device 1A is a device having a static elimination function of performing static elimination for reducing charge (a charge amount) charged on a sheet-like material 9.

In the static elimination device 1A according to the first embodiment, a first static elimination unit 2, a second static elimination unit 3, a transport path 15 for transporting the sheet-like material 9, and the like are disposed in a housing 10 as illustrated in FIG. 1A in a state in which the inside is seen through.

The sheet-like material 9 is a medium having a sheet-like form, such as paper, which can be transported in the static elimination device 1A. The sheet-like material 9 is fed into the housing 10 from a device used in combination with the static elimination device 1A, or is fed into the housing 10 by a feeder (not illustrated) in a case where the static elimination device 1A is used alone.

Regarding the sheet-like material 9, a sheet-like material 9A that needs to be subjected to static elimination and has an adhesive layer (93) to be described later will be mainly described in the first embodiment and other embodiments to be described later.

The housing 10 is a box-shaped structure that is assembled using materials such as various support materials and exterior materials. The housing 10 has an inlet 10a through which the sheet-like material 9 is introduced into the internal space and an outlet 10b through which the sheet-like material 9 is ejected to the outside.

The housing 10 is necessary in a case where the static elimination device 1A is used alone in a state of being exposed to the outside. Thus, the housing 10 can be omitted in a case where the static elimination device 1A is used by being disposed in a housing of another device.

### (1-2) First Static Elimination Unit

The first static elimination unit 2 includes a pair of static elimination rollers 20 that performs static elimination of the sheet-like material 9 by allowing the sheet-like material 9 to pass therebetween, and a power supply device 23 that is an example of a power supply unit supplying a voltage for static elimination to at least one of the pair of static elimination rollers 20.

The pair of static elimination rollers 20 is a combination of two static elimination rollers 21 and 22.

In addition, the pair of static elimination rollers 20 is rotatably supported in a state in which the two static elimination rollers 21 and 22 are substantially aligned in an axial direction J and brought into contact with each other, except for a pair of static elimination rollers 20C in a third embodiment to be described later.

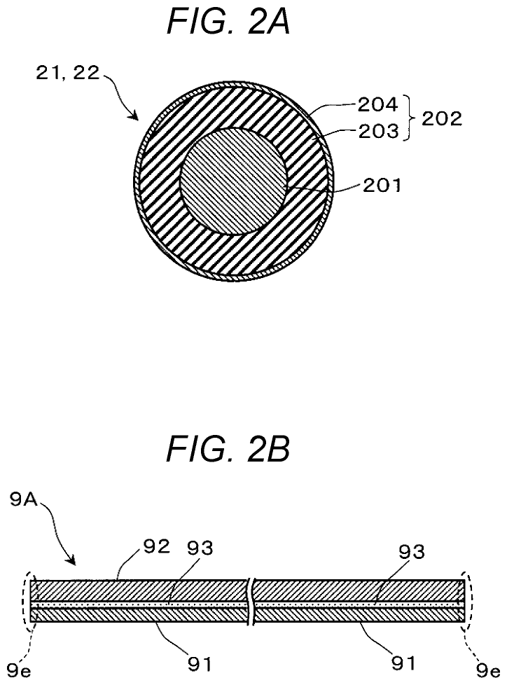

As illustrated in FIG. 2A, each of the two static elimination rollers 21 and 22 includes a shaft 201 and a roller body 202 provided at a predetermined portion of the shaft 201.

The shaft 201 has conductivity and is made of, for example, a material such as metal.

The roller body 202 includes an elastic layer 203 provided on an outer circumference of the shaft 201 and a protective layer 204 provided on a surface of the elastic layer 203.

The elastic layer 203 is, for example, a layer obtained by blending a conductive material in a substrate such as rubber, and is prepared to have an electrical resistivity in a range of about 10⁴ Ω·cm to 10¹⁰ Ω·cm. The protective layer 204 is, for example, a layer made of a material such as a fluorine-based resin. Note that the protective layer 204 may be omitted.

At least one static elimination roller 21 of the pair of static elimination rollers 20 receives rotational power from an electric motor via a power transmission mechanism and is driven to rotate at a required speed in a required direction. The other static elimination roller 22 is, for example, rotated in contact with the one static elimination roller which is driven to rotate.

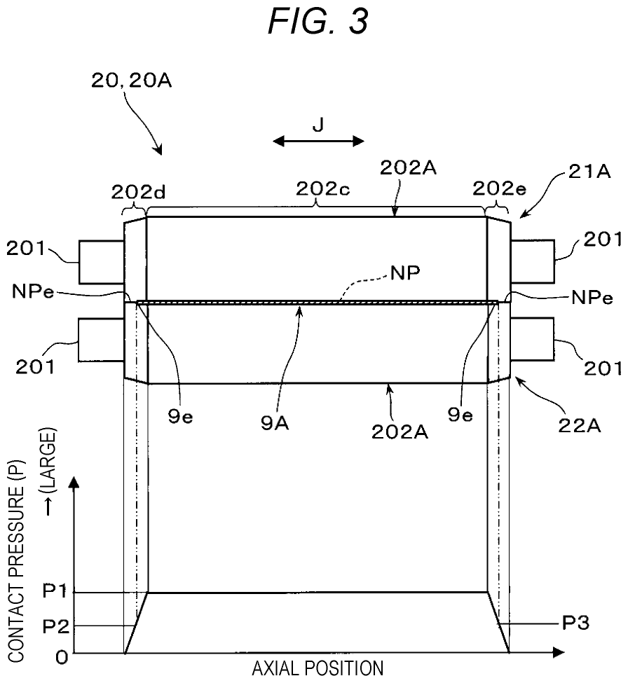

Further, in the pair of static elimination rollers 20, a distance between the shafts 201 (distance between shafts) is set such that the roller bodies 202 of the two static elimination rollers 21 and 22 come into contact with each other at a required contact pressure P1. Thus, in the pair of static elimination rollers 20, a portion NP (see FIG. 3 and the like) where the roller bodies 202 of the two static elimination rollers 21 and 22 are in contact with each other is in a state of being elastically deformed by a required width in a rotating direction. A contact pressure P is a pressure at the portion NP where the roller bodies 202 are in contact with each other.

As illustrated in FIG. 1A, the power supply device 23 supplies a DC voltage or a voltage obtained by superimposing an alternating current on a direct current to the shaft 201 of the one static elimination roller 21 of the pair of static elimination rollers 20 as the voltage for static elimination at a static elimination operation timing. In this case, the shaft 201 of the other static elimination roller 22 of the pair of static elimination rollers 20 is grounded.

In addition, the power supply device 23 supplies the voltage for static elimination by constant voltage control in which an output voltage is controlled to be constant.

### (1-3) Second Static Elimination Unit

The second static elimination unit 3 is a unit that performs static elimination of the sheet-like material 9 in a non-contact state after the static elimination by the first static elimination unit 2. Thus, as illustrated in FIG. 1A, the second static elimination unit 3 is disposed at a position on the downstream side of the first static elimination unit 2 in a transport direction E of the sheet-like material 9.

The second static elimination unit 3 includes a non-contact static eliminator 30 that performs static elimination in a non-contact state, and a power supply device 33 that is an example of a power supply unit supplying a voltage for static elimination to the non-contact static eliminator 30.

The non-contact static eliminator 30 is disposed so as to face one surface of the sheet-like material 9 after being subjected to the static elimination by the first static elimination unit 2 with a required interval therebetween.

The non-contact static eliminator 30 is configured using, for example, a corotron or scorotron corona discharger. The corona discharger, which is the non-contact static eliminator 30, is disposed to have a discharge wire being substantially parallel to the entire area in a width direction of the sheet-like material 9 during transport. The width direction of the sheet-like material 9 during transport is also a direction substantially parallel to the axial direction J of the pair of static elimination rollers 20.

The power supply device 33 supplies an AC voltage as the voltage for static elimination to the discharge wire in the corona discharger of the non-contact static eliminator 30 at the static elimination operation timing.

The power supply device 33 may be disposed as an independent power supply unit for the second static elimination unit 3, or may be configured as one power supply unit common to the power supply device 23 of the first static elimination unit 2.

### (1-4) Transport Path

The transport path 15 is a portion through which the sheet-like material 9 is transported so as to pass through the pair of static elimination rollers 20 of the first static elimination unit 2 and the second static elimination unit 3 in this order inside the housing 10.

In addition, the transport path 15 includes a plurality of transport roller pairs 16, 17, and 18, a transport guide (not illustrated), and the like.

Each of the transport roller pairs 16, 17, and 18 transports the sheet-like material 9 while sandwiching the sheet-like material 9 between two transport rollers that rotate in contact with each other.

Each of the two transport rollers forming each of the transport roller pairs 16, 17, and 18 has a structure in which a plurality of roller bodies are attached to a shaft (not illustrated) at an interval. One of the two transport rollers receives rotational power and is driven to rotate at a required speed in a required direction, and the other transport roller is rotated in contact with the one transport roller.

In the first embodiment, the transport roller pair 16 is the upstream transport roller pair 16 that is disposed first on the upstream side of the pair of static elimination rollers 20 of the first static elimination unit 2 in the transport direction E of the sheet-like material 9. In addition, the transport roller pair 16 also as a transport roller pair that transports the sheet-like material 9 fed through the inlet 10a into the housing 10.

The transport roller pair 17 is the downstream transport roller pair 17 that is disposed first on the downstream side of the pair of static elimination rollers 20 in the transport direction E. In addition, the transport roller pair 17 also serves as a transport roller pair which is disposed first on the upstream side of the second static elimination unit 3 in the transport direction E.

The transport roller pair 18 is disposed first on the downstream side of the second static elimination unit 3 in the transport direction E. The transport roller pair 18 transports the sheet-like material 9 from the inside of the housing 10 to the outside through the outlet 10b.

### (1-5) Sheet-Like Material and Defect

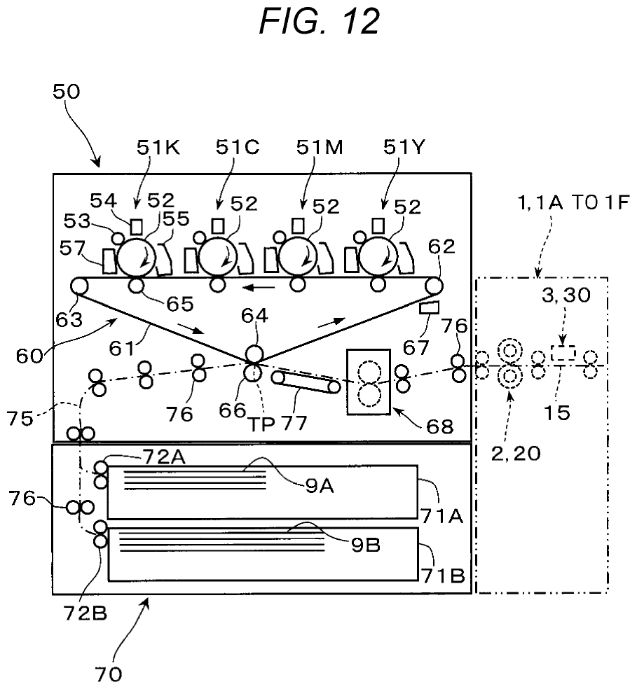

In the static elimination device 1A according to the first embodiment, the sheet-like material 9A having a multilayer structure and including an adhesive layer 93 between layers is applied as the sheet-like material 9 as illustrated in FIG. 2B. Meanwhile, it is also possible to apply a sheet-like material 9B (see FIG. 12) that does not have the adhesive layer 93 as the sheet-like material 9 in the static elimination device 1A.

The sheet-like material 9A illustrated in FIG. 2B is a sheet member in which a body layer 92 is laminated on a substrate 91 via the adhesive layer 93. The substrate 91 is a release layer or a mount that is released at the final stage of use. The body layer 92 is a layer in which various types of information such as an image can be recorded or a layer in which various types of information have been recorded.

Such a sheet-like material 9A is used for applications as, for example, a label sheet, a sealing sheet, or the like. The sheet-like material 9A may have a multilayer structure of four or more layers. In addition, the sheet-like material 9A may have defined shape and size, or may be an elongated continuous material that is long in one direction and is finally cut and used in a state of being divided into a required size.

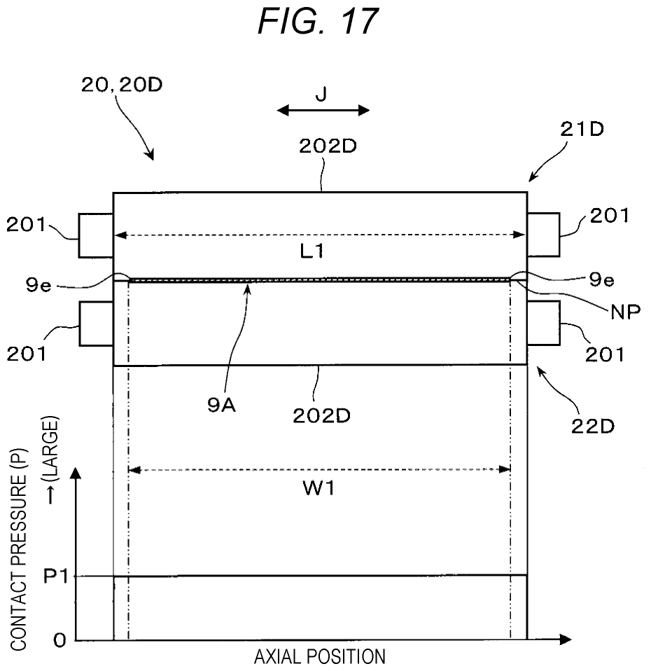

Here, a static elimination device in which a pair of static elimination rollers 20D which come into contact with each other at the required contact pressure P1 over the entire area in the width direction of the sheet-like material 9A are applied as the pair of static elimination rollers 20 as illustrated in FIG. 17 has the following defect.

The pair of static elimination rollers 20D is formed by disposing two static elimination rollers 21D and 22D each having a roller body 202D in contact with each other such that the contact pressure P becomes the required contact pressure P1, the roller body 202D having a length L1 in the axial direction J that is longer than a maximum width W1 of the sheet-like material 9A during transport.

The above-described defect is that in a case where the sheet-like material 9A is allowed to pass through the portion NP where the static elimination rollers 21D and 22D of the pair of static elimination rollers 20D are in contact with each other to eliminate static electricity, adhesive components of the adhesive layer 93 protrude from both ends 9e and 9e of the sheet-like material 9A and are transferred to adhere to the static elimination rollers 21D and 22D.

In the pair of static elimination rollers 20D to which the adhesive components adhere, static elimination performance in a portion to which the adhesive component adheres is different from static elimination performance in the other portion, and uneven static elimination is likely to occur.

### (1-6) Pair of Static Elimination Rollers

Therefore, as illustrated in FIGS. 1B and 3, a pair of static elimination rollers 20A, configured such that contact pressures P2 and P3 at ends 202d and 202e in the axial direction J are lower than the contact pressure P1 at an inner portion 202c which is a portion other than the ends, is adopted as the pair of static elimination rollers 20 in the static elimination device 1A.

As illustrated in FIG. 1B, the pair of static elimination rollers 20A having the lower contact pressures at the ends thereof is constituted by, as the two static elimination rollers 21 and 22, static elimination rollers 21A and 22A that include roller bodies 202A having shapes in which outer diameters D2 and D3 and outer diameters D5 and D6 of the ends 202d and 202e are smaller than outer diameters D1 and D4 of the inner portions 202c, respectively.

In the static elimination roller 21A and the static elimination roller 22A, for example, the outer diameters D1 and the D4 of the respective inner portions 202c in the roller bodies 202A are set to the same dimension. In addition, the inner portions 202c have the constant outer diameters D1 and D4 in the axial direction J. Note that columnar shafts having the same outer diameter are applied as the shafts 201.

The ends 202d and 202e of the static elimination roller 21A are formed in slope shapes in which the respective outer diameters D2 and D3 gradually decrease as distances from the inner portion 202c increase toward the outside. In addition, the ends 202d and 202e of the static elimination roller 22A are also formed in slope shapes in which the respective outer diameters D5 and D6 gradually decrease as distances from the inner portion 202c increase toward the outside.

Each of the ends 202d and 202e of the roller body 202A in the static elimination rollers 21A and 22A is an area having such a length in the axial direction J as to enable contact and passage of both the ends 9e and 9e of the sheet-like material 9A having the maximum width W1 during the static elimination.

In addition, for the ends 202d and 202e of the static elimination roller 21A, for example, conditions for the outer diameters D2 and D3 and the like are selected from the viewpoint of setting the contact pressures P2 and P3 at portions where both the ends 9e and 9e of the sheet-like material 9A are assumed to pass to required low pressures.

As illustrated in FIGS. 1B and 3, the pair of static elimination rollers 20A is used in contact with each other such that the inner portions 202c of the respective roller bodies 202A in the static elimination rollers 21A and 22A are at the required contact pressure P1.

At this time, the inner portions 202c of the roller bodies 202A of the static elimination rollers 21A and 22A are elastically deformed and brought into contact with each other by a predetermined width in the rotating direction, thereby forming the portion NP where the contact is made to allow passage of the sheet-like material 9.

At this time, as illustrated in FIG. 3, the ends 202d and 202e of the respective roller bodies 202A of the static elimination rollers 21A and 22A are elastically deformed and brought into contact with each other, thereby forming end portions NPe where the contact is made to allow passage of the ends 9e and 9e of the sheet-like material 9.

In addition, in the pair of static elimination rollers 20A, the ends 202d and 202e of the static elimination rollers 21A and 22A have the outer diameters D2, D3, D5, and D6 smaller than the outer diameters D1 and D4 of the inner portions 202c. Thus, the contact pressures P2 and P3 at the ends 202d and 202e are lower than the contact pressure P1 at the inner portion 202c as illustrated in FIG. 3.

That is, the contact pressures P2 and P3 at the ends 202d and 202e have a magnitude relation of inequality of “0<P2<P1” and “0<P3<P1” with respect to the contact pressure P1. At this time, the contact pressure P2 and the P3 gradually decrease as a position is farther from the inner portion 202c of the roller body 202A. At this time, the contact pressures P2 and P3 are the same, but may be slightly different from each other.

In addition, the contact pressures P2 and P3 at the ends 202d and 202e are preferably pressures in a range of 0.8 times or less excluding 0 times with respect to the contact pressure P1 of the inner portion 202c, for example.

Further, in the pair of static elimination rollers 20A, the contact pressure P1 at the portion NP where the inner portions 202c of the roller bodies 202A of the static elimination rollers 21A and 22A are in contact with each other is preferably set to be lower than a contact pressure of the upstream transport roller pair 16. That is, contact pressures (all of P1, P2, and P3) in the entire area in the axial direction J of the roller bodies 202A of the static elimination rollers 21A and 22A are preferably lower than the contact pressure of the upstream transport roller pair 16.

### (1-7) Operation of Static Elimination Device, Etc.

In the static elimination device 1A, when the static elimination operation timing comes, the pair of static elimination rollers 20A in the first static elimination unit 2 and the plurality of transport roller pairs 16, 17, and 18 start to rotate. In addition, a required voltage is supplied from the power supply device 23 to the static elimination roller 21A of the pair of static elimination rollers 20A in the first static elimination unit 2. Further, a required voltage is supplied from the power supply device 33 to the non-contact static eliminator 30 in the second static elimination unit 3.

Subsequently, when the sheet-like material 9A that is charged and set as a static elimination target is fed into the housing 10, the static elimination device 1A performs static elimination while transporting the sheet-like material 9A to pass through the first static elimination unit 2 and the second static elimination unit 3 in this order through the transport path 15.

In the first static elimination unit 2, the sheet-like material 9A is introduced by the upstream transport roller pair 16 into the portion NP and the end portions NPe where the pair of static elimination rollers 20A are in contact and is allowed to pass therethrough. At this time, discharging occurs between the static elimination roller 21A and the sheet-like material 9A in minute voids before and after each of the portion NP and the end portions NPe where the static elimination rollers 21A and 22A constituting the pair of static elimination rollers 20A are in contact.

Therefore, charge having a polarity opposite to a polarity (for example, a negative polarity) of charge on a surface of the charged sheet-like material 9A is applied from the static elimination roller 21A. As a result, the charge on the surface of the sheet-like material 9A is reduced by the amount of the applied charge having the opposite polarity. At this time, charge having a polarity subjected to dielectric polarization disappears and decreases on a rear surface of the sheet-like material 9A.

Therefore, the sheet-like material 9A is subjected to the static elimination when passing between the pair of static elimination rollers 20A of the first static elimination unit 2 so as to be sandwiched therebetween.

Note that the sheet-like material 9A that has passed between the pair of static elimination rollers 20A is transported toward the second static elimination unit 3 by the downstream transport roller pair 17.

In the pair of static elimination rollers 20A, each of the outer diameters D1 and D4 of the inner portions 202c in the roller bodies 202A is constant.

Thus, static elimination in the inner portion other than the ends in the width direction during transport of the sheet-like material 9A is likely to be uniformly performed in the pair of static elimination rollers 20A as compared with a case where those having gradually increasing outer diameters D1 and D4 of inner portions of the roller bodies 202 are adopted as the pair of static elimination rollers 20A having the lower contact pressures at the ends thereof.

Further, in the pair of static elimination rollers 20A, the contact pressures P between the roller bodies 202A in the static elimination rollers 21A and 22A have a relation in which the contact pressure P1 of the inner portion 202c is different from the contact pressures P2 and P3 at both the ends 202d and 202e.

In the pair of static elimination rollers 20A, however, the voltage for static elimination is supplied to the one static elimination roller 21 from the power supply device 23 by the constant voltage control.

Thus, portions where the contact pressures P are different such as the contact pressure P1 and the contact pressures P2 and P3 coexist in the pair of static elimination rollers 20A, but the occurrence of uneven static elimination on the sheet-like material 9A or the occurrence of excessive static elimination and charging to an opposite polarity is suppressed as compared with a case where the power supply device 23 performs power supply by constant current control.

There is a possibility that the uneven static elimination at this time occurs due to a difference in the contact pressure P in the portions with the contact pressure P2 and the contact pressure P3 of the pair of static elimination rollers 20A. However, the uneven static elimination is also suppressed by the power supply under the constant current control in the pair of static elimination rollers 20A.

Next, in the second static elimination unit 3, the sheet-like material 9A is allowed to pass below the non-contact static eliminator 30 in the non-contact state by the transport roller pair 17 and the transport roller pair 18 on the downstream side. At this time, ions generated by corona discharge in the non-contact static eliminator 30 of the second static elimination unit 3 are supplied to the surface of the sheet-like material 9A.

Therefore, even in a case where charge remains non-uniform on the surface of the sheet-like material 9A after passing through the first static elimination unit 2, the non-uniform charge is eliminated by the supplied ions. As a result, the amount of variation in surface potential is suppressed in the sheet-like material 9A.

Therefore, the sheet-like material 9A after having passed through the first static elimination unit 2 passes through the second static elimination unit 3, whereby uniform static elimination can be performed as compared with a case where only the static elimination by the first static elimination unit 2 is performed.

In the static elimination device 1A, in a case where static elimination is performed by allowing the sheet-like material 9A having the adhesive layer 93 to pass through the pair of static elimination rollers 20A by the first static elimination unit 2, the sheet-like material 9A passes with both the ends 9e and 9e being in contact with the ends 202d and 202e of the roller bodies 202A of the static elimination rollers 21A and 22A constituting the pair of static elimination rollers 20A as illustrated in FIG. 3.

At this time, in the static elimination rollers 21A and 22A, pressures applied to both the ends 9e and 9e of the sheet-like material 9A at the end portions NPe where the ends 202d and 202e of the roller bodies 202A are in contact with each other at the contact pressures P2 and P3 is relatively lower than a pressure applied at the portion NP where the inner portions 202c of the roller bodies 202A are in contact with each other at the contact pressure P1.

Therefore, even in a case where the sheet-like material 9A having the adhesive layer 93 is subjected to the static elimination while passing between the pair of static elimination rollers 20A, it is possible to reduce the possibility that both the ends 9e and 9e of the sheet-like material 9A and a portion in the vicinity thereof receive such a pressure as to cause the adhesive components of the adhesive layer 93 to protrude.

As a result, in the static elimination device 1A, the adhesive components of the adhesive layer 93 protruding from both the ends 9e and 9e of the sheet-like material 9A are prevented from adhering to the roller bodies 202A of the static elimination rollers 21A and 22A as compared with a case where the pair of static elimination rollers 20D that come into contact with each other over the entire area in the width direction of the sheet-like material 9A come into contact with each other at a constant contact pressure (refer to FIG. 17).

By the way, the pair of static elimination rollers 20A having the lower contact pressures at the ends thereof may be configured such that the contact pressure P1 at the portion NP where the inner portions 202c of the roller bodies 202A of the static elimination rollers 21A and 22A are in contact with each other is lower than the contact pressure of the upstream transport roller pair 16. In this case, the adhesion of the adhesive components of the adhesive layer 93 on the sheet-like material 9A is more easily prevented by the pair of static elimination rollers 20A.

In addition, regarding the pair of static elimination rollers 20A, there is a possibility that the uneven static elimination occurs in the portions with the contact pressures P2 and P3 where the contact pressures P are relatively lower than the contact pressure P1. As countermeasures therefor, for example, it is effective to set electrical resistivities of the elastic layers 203 in the portions that are to receive the contact pressures P2 and P3 of the pair of static elimination rollers 20A to be lower than an electrical resistivity of the elastic layer 203 in the portion that is to receive the contact pressure P1. In addition, the protective layers 204 in the portions that are to receive the contact pressures P2 and P3 of the pair of static elimination rollers 20A are eliminated.

When such countermeasures are adopted in the pair of static elimination rollers 20A, electrical resistances in the portions corresponding to the contact pressures P2 and P3 relatively decrease so that the static elimination performance can be relatively enhanced.

Further, even if the sheet-like material 9A has a width smaller than the maximum width W1, the adhesive components of the adhesive layer 93 are prevented from adhering to the static elimination rollers 21A and 22A as long as the width allows both the ends 9e and 9e to be in contact with the end portions NPe where the ends 202d and 202e of the pair of static elimination rollers 20A come into contact with each other at the contact pressure P2 and P3.

### (1-8) Modification 1 of Pair of Static Elimination Rollers

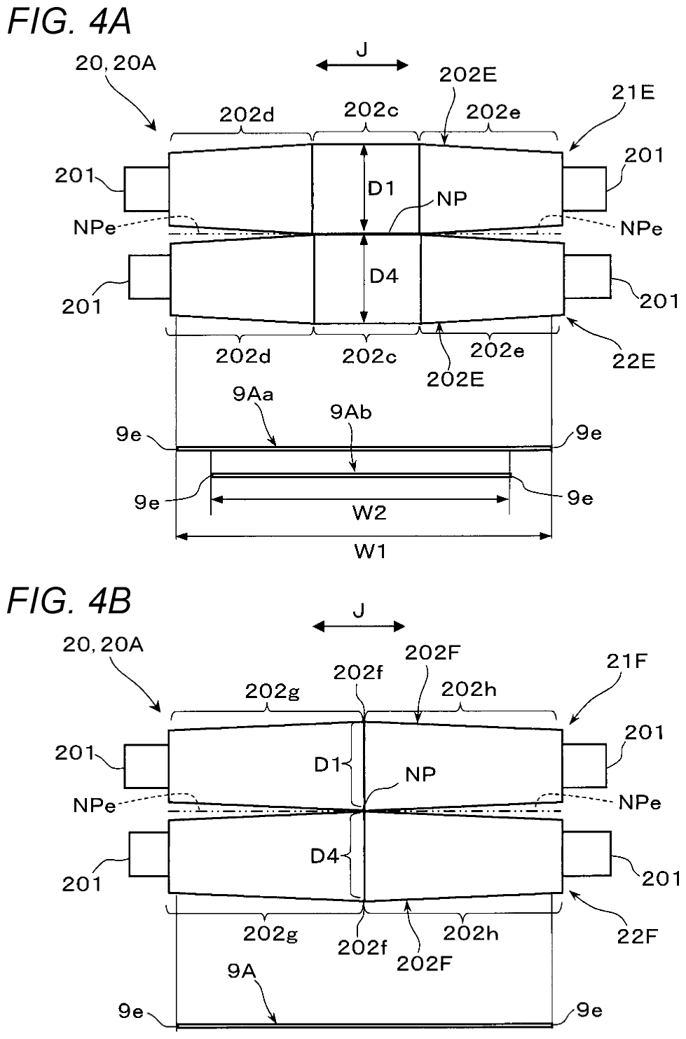

As illustrated in FIG. 4A, the pair of static elimination rollers 20A of Modification 1 constituted by static elimination rollers 21E and 22E each including a roller body 202E having whose ends 202d and 202e where the contact pressures P2 and P3 are low have large lengths (widths) in the axial direction J may be adopted as the pair of static elimination rollers 20A in the static elimination device 1A.

The ends 202d and 202e whose lengths in the axial direction are large have the lengths that are the same or equal to or larger than a length in the axial direction J of the inner portion 202c.

In a case where the pair of static elimination rollers 20A of Modification 1 including the static elimination rollers 21E and 22E is used, even when a sheet-like material 9Ab having a width W2 (<W1) smaller than a sheet-like material 9Aa having the maximum width W1 is used as illustrated in FIG. 4A, static elimination can be performed by allowing both the ends 9e and 9e of the sheet-like material 9Ab to pass through the end portion NPe where the ends 202d and 202e having the lower contact pressures P2 and P3 are in contact with each other. That is, the static elimination device 1A becomes a static elimination device to which a plurality of types of the sheet-like materials 9A having different widths W during transport are easily applied.

### (1-9) Modification 2 of Pair of Static Elimination Rollers

As illustrated in FIG. 4B, the pair of static elimination rollers 20A of Modification 2 constituted by static elimination rollers 21F and 22F each including a roller body 202F that has only the ends 202d and 202e with the lower contact pressures P2 and P3 since the inner portions 202c with the contact pressure P1 has substantially no length in the axial direction J may be adopted as the pair of static elimination rollers 20A in the static elimination device 1A.

The roller body 202F at this time becomes a crown-shaped roller body.

In a case where the pair of static elimination rollers 20A of Modification 2 including the static elimination rollers 21F and 22F is applied, it is possible to provide the static elimination device 1A to which a plurality of types of the sheet-like materials 9A having different widths W during transport can be more easily applied as compared with the case where the pair of static elimination rollers 20A of Modification 1 is applied.

### Second Embodiment

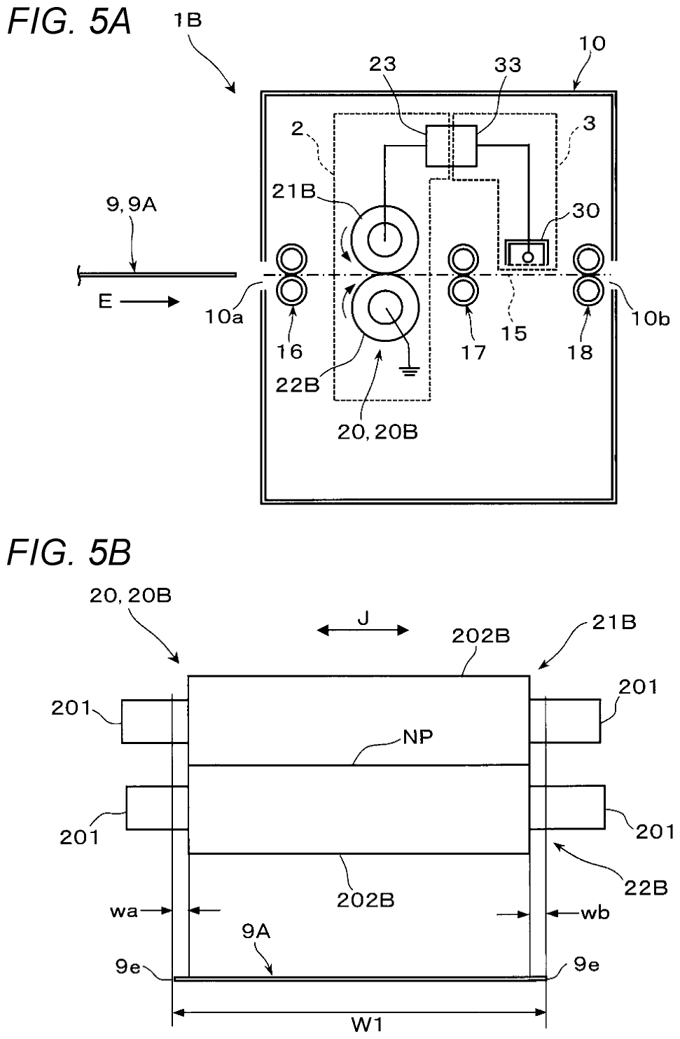

FIGS. 5A and 5B are conceptual diagrams illustrating a whole and a part of a static elimination device 1B according to a second embodiment of the present invention.

### (2-1) Basic Configuration of Static Elimination Device

As illustrated in FIG. 5A, the static elimination device 1B according to the second embodiment has the same configuration as that of the static elimination device 1A according to the first embodiment (FIGS. 1A and 1B and the like) except for a change caused by adopting a pair of static elimination rollers 20B having a different configuration instead of the pair of static elimination rollers 20A in the first embodiment as the pair of static elimination rollers 20 in the first static elimination unit 2.

### (2-2) Pair of Static Elimination Rollers

The pair of static elimination rollers 20B is a pair of static elimination rollers configured so as not to come into contact with the ends 9e and 9e in the width direction of the sheet-like material 9A.

As illustrated in FIG. 5B, the pair of static elimination rollers 20B in the second embodiment is formed as rollers whose lengths in the axial direction J are shorter than the maximum width W1 of the sheet-like material 9A. In other words, the pair of static elimination rollers 20B is configured to bring static elimination rollers 21B and 22B each having a roller body 202B whose length in the axial direction J is shorter than the maximum width W1 of the sheet-like material 9A into contact with each other on the roller bodies 202B.

It is sufficient that lengths to be shortened are lengths at which the roller bodies 202B do not come into contact with the ends 9e and 9e in the width direction of the sheet-like material 9A.

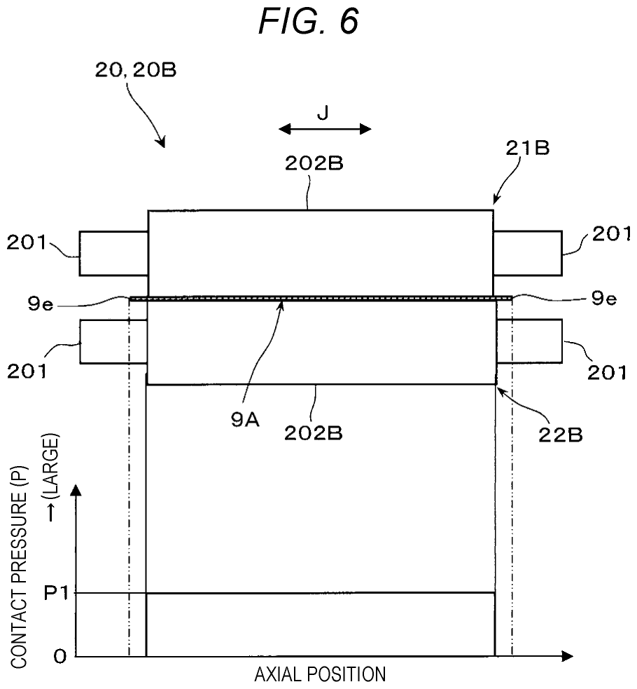

As illustrated in FIGS. 5B and 6, the pair of static elimination rollers 20B that do not come into contact with the ends of the sheet-like material 9A are used by allowing the respective roller bodies 202B of the static elimination rollers 21B and 22B to be in contact with each other at the required contact pressure P1.

At this time, the roller bodies 202B of the static elimination rollers 21B and 22B are elastically deformed and brought into contact with each other by a predetermined width in the rotating direction, thereby forming the portion NP where the contact is made to allow passage of the sheet-like material 9.

Further, in the pair of static elimination rollers 20B which do not come into contact with the ends of the sheet-like material 9A, the contact pressure P1 of the portion NP where the roller bodies 202B of the static elimination rollers 21B and 22B come into contact with each other is preferably set to be lower than a contact pressure of the upstream transport roller pair 16.

### (2-3) Operation of Static Elimination Device, Etc.

The static elimination device 1B performs static elimination in the substantially same manner as in the case of the static elimination device 1A according to the first embodiment except for the following differences while transporting the sheet-like material 9A through the transport path 15 so as to pass through the first static elimination unit 2 and the second static elimination unit 3 in this order when the static elimination operation timing arrives and the sheet-like material 9A to be subjected to static elimination is sent into the housing 10.

At this time, static elimination by the first static elimination unit 2 is performed only on a portion of the sheet-like material 9A which passes in contact with the roller bodies 202B of the static elimination rollers 21B and 22B of the pair of static elimination rollers 20B in the first static elimination unit 2.

In the static elimination device 1B, in a case where static elimination is performed by allowing the sheet-like material 9A having the adhesive layer 93 to pass through the pair of static elimination rollers 20B by the first static elimination unit 2, the sheet-like material 9A passes without causing both the ends 9e and 9e to come into contact with the roller bodies 202B of the static elimination rollers 21B and 22B constituting the pair of static elimination rollers 20B as illustrated in FIG. 6.

Therefore, even in a case where the sheet-like material 9A having the adhesive layer 93 is subjected to the static elimination while passing between the pair of static elimination rollers 20B, the sheet-like material 9A does not receive such a pressure as to cause adhesive components of the adhesive layer 93 to protrude on both the ends 9e and 9e and a portion in the vicinity thereof.

As a result, in the static elimination device 1B, the adhesive components of the adhesive layer 93 protruding from both the ends 9e and 9e of the sheet-like material 9A are prevented from adhering to the roller bodies 202B of the static elimination rollers 21B and 22B as compared with a case where the pair of static elimination rollers 20D that come into contact with each other over the entire area in the width direction of the sheet-like material 9A having the adhesive layer 93 come into contact with each other at a constant contact pressure (refer to FIG. 17).

Incidentally, in a case where the pair of static elimination rollers 20B is configured such that the contact pressure P1 of the portion NP where the roller bodies 202B of the static elimination rollers 21B and 22B come into contact with each other is lower than the contact pressure of the upstream transport roller pair 16, the following occurs.

That is, the contact pressure P1 of the pair of static elimination rollers 20B in this case is lower than the contact pressure of the upstream transport roller pair 16, but the adhesive components of the adhesive layer 93 in the sheet-like material 9A are easily prevented from adhering to the pair of static elimination rollers 20B while maintaining the transport capability with respect to the sheet-like material 9A.

In addition, in the static elimination device 1B, no static elimination is performed on the ends of the sheet-like material 9A (including the sheet-like material 9B) that do not come into contact with the pair of static elimination rollers 20B. To cope with such a case, the end can be finally cut and removed when the end is a portion that causes no problem even if being absent. In addition, there is also a case where it is not necessary to perform static elimination on the end since an image formed of a toner is not formed in an image forming section 50 in the end which is not subjected to the static elimination as above and the end is not charged.

Further, even if the width W of the sheet-like material 9A during transport is smaller than the maximum width W1, the adhesive components of the adhesive layer 93 are prevented from adhering to the static elimination rollers 21B and 22B as long as the width allows the passage without coming into contact with the roller bodies 202B of the static elimination rollers 21B and 22B of the pair of static elimination rollers 20B.

### (2-4) Modification 3 of Pair of Static Elimination Rollers

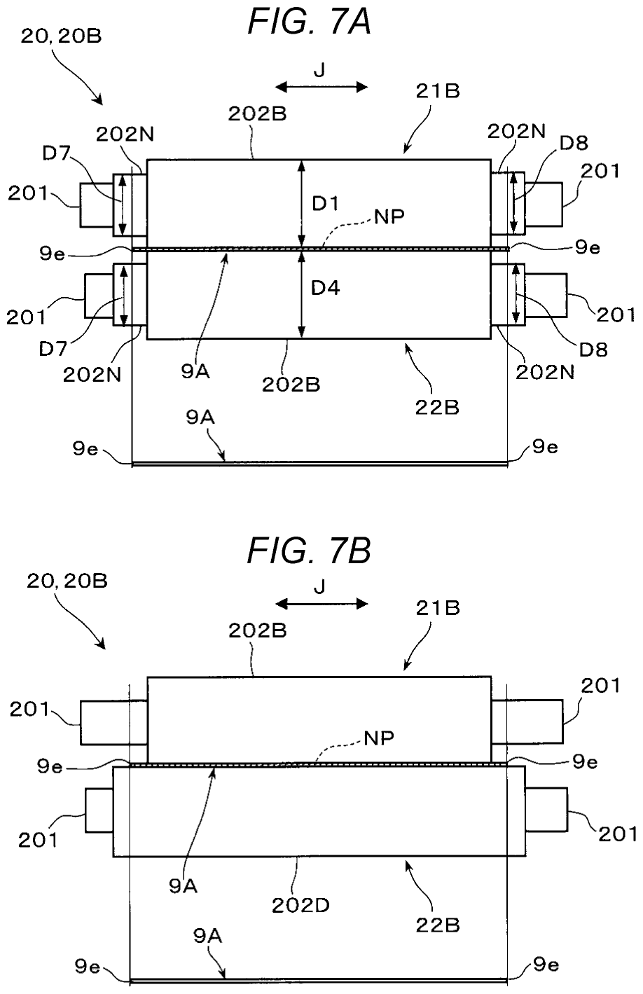

As illustrated in FIG. 7A, the pair of static elimination rollers 20B of Modification 3 constituted by the static elimination rollers 21B and 22B in which end roller members 202N each having a smaller diameter and outer diameters D7 and D8 smaller than the outer diameters D1 and D4 of the roller bodies 202B are disposed on both sides of the roller bodies 202B, respectively, may be adopted as the pair of static elimination rollers 20B in the static elimination device 1B.

The outer diameters D7 and the D8 of the end roller member 202N are not particularly limited as long as dimensions thereof do not allow contact with both the ends 9e and 9e of the sheet-like material 9A passing to be sandwiched between the pair of static elimination rollers 20B.

As illustrated in FIG. 7A, when the static elimination is performed by the first static elimination unit 2 in the pair of static elimination rollers 20B of Modification 3 including the static elimination rollers 21B and 22B in which the above small-diameter end roller members 202N are disposed, the small-diameter end roller members 202N are in a state of being close to both the ends 9e and 9e of the sheet-like material 9A.

Thus, in a case where the pair of static elimination rollers 20B of Modification 3 is adopted, there is a possibility that static elimination is slightly performed on ends near both the ends 9e in the width direction of the sheet-like material 9A during transport as compared with a case where those including the small-diameter end roller members 202N disposed at the ends thereof are adopted as the pair of static elimination rollers 20B that do not come into contact with both the ends of the sheet-like material.

### (2-5) Modification 4 of Pair of Static Elimination Rollers

As illustrated in FIG. 7B, the pair of static elimination rollers 20B of Modification 4 constituted by the static elimination roller 21B including the above-described roller body 202B and the static elimination roller 22B whose length in the axial direction J is longer than the maximum width W1 of the sheet-like material 9A may be adopted as the pair of static elimination rollers 20B in the static elimination device 1B.

In a case where the pair of static elimination rollers 20B of Modification 4 including the static elimination rollers 21B and 22B is adopted, the sheet-like material 9A including both the ends thereof can be supported by the static elimination rollers 22B from below and stably transported when the static elimination is performed by the first static elimination unit 2 as compared with a case where the pair of static elimination rollers 20B (see FIG. 5B) in which the static elimination roller 22B is not applied is adopted.

### Third Embodiment

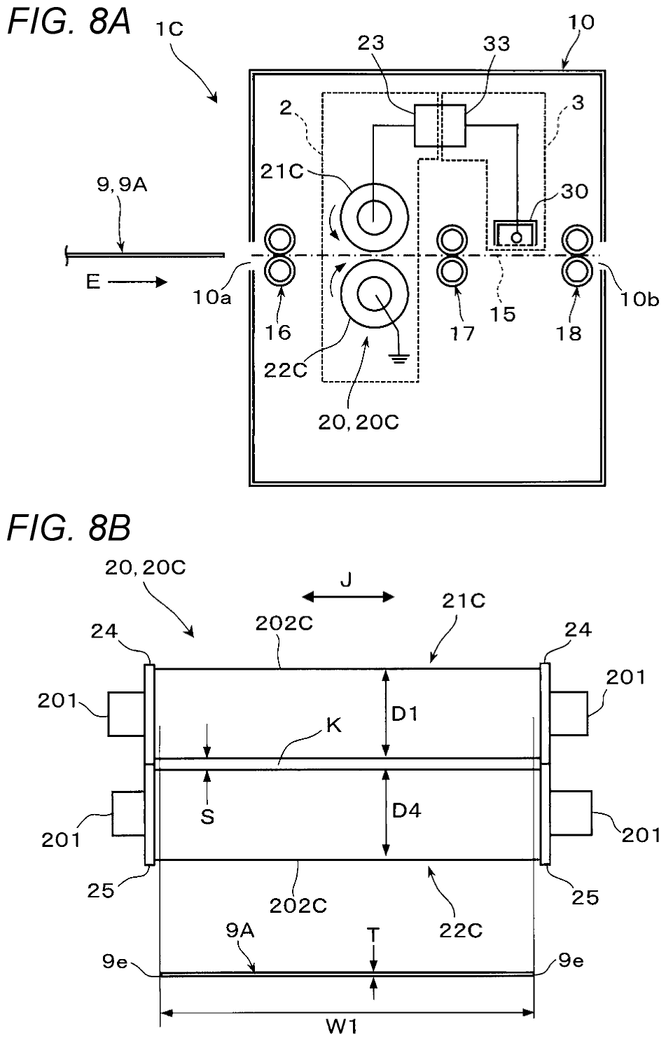

FIGS. 8A and 8B are conceptual diagrams illustrating a whole and a part of a static elimination device 1C according to a third embodiment of the present invention.

### (3-1) Basic Configuration of Static Elimination Device

As illustrated in FIG. 8A, the static elimination device 1C according to the third embodiment has the same configuration as that of the static elimination device 1A according to the first embodiment (FIGS. 1A and 1B and the like) except for a change caused by adopting a pair of static elimination rollers 20C having a different configuration instead of the pair of static elimination rollers 20A in the first embodiment as the pair of static elimination rollers 20 in the first static elimination unit 2.

### (3-2) Pair of Static Elimination Rollers

The pair of static elimination rollers 20C is a pair of static elimination rollers constituted by static elimination rollers 21C and 22C that do not come into contact with each other and are disposed in a non-contact state.

As illustrated in FIG. 8B, the pair of static elimination rollers 20C according to the third embodiment is held in a non-contact state by void holding members 24 and 25 that hold a void K between both the static elimination rollers 21C and 22C.

As the void holding members 24 and 25, for example, members which are disposed at both ends of roller bodies 202C having the outer diameters D1 and D4 of the static elimination rollers 21C and 22C and are formed using disks whose outer diameters are larger than the outer diameters D1 and D4 of the roller bodies 202C by predetermined dimensions are applied. The void holding members 24 and 25 formed using the disks are disposed to be fixed to both the ends of the roller bodies 202C and to be in contact with each other.

Lengths of the roller bodies 202C of the static elimination rollers 21C and 22C in the pair of static elimination rollers 20C in the axial direction J are longer than the maximum width W1 of the sheet-like material 9A.

As illustrated in FIG. 8B and the like, the pair of static elimination rollers 20C disposed in the above-described non-contact state is used in a state in which the roller bodies 202C of the static elimination rollers 21C and 22C face each other with the void K formed therebetween by the void holding members 24 and 25 formed using the disks.

At this time, the roller bodies 202C of the static elimination rollers 21C and 22C do not come into contact with each other, and the void K having a predetermined interval S is formed.

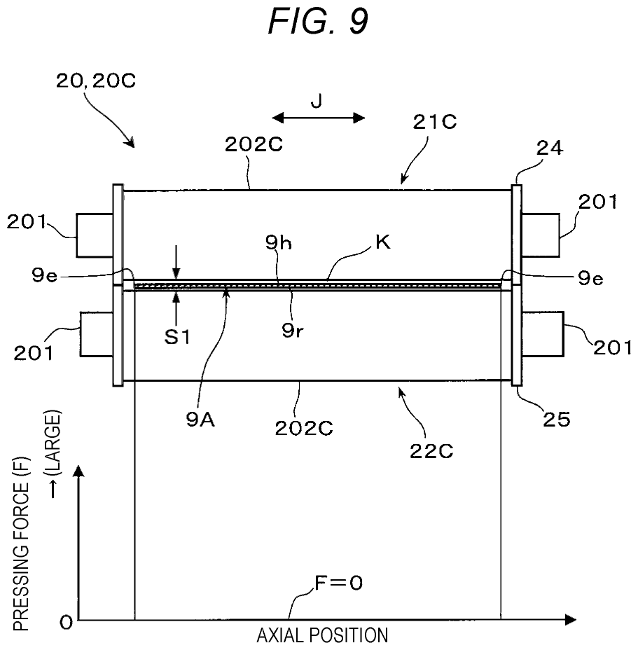

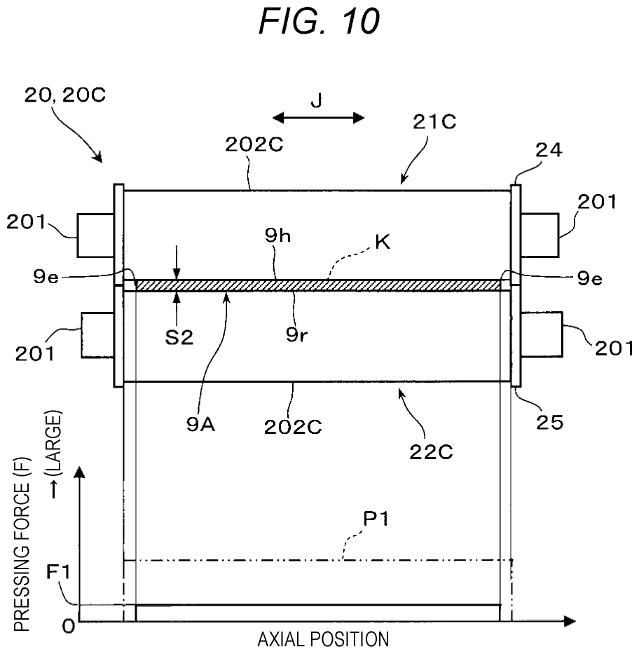

The interval S of the void K may have either a dimension S1 larger than a thickness T of the sheet-like material 9A (S1>T) as illustrated in FIG. 9 or a dimension S2 equal to or smaller than the thickness T of the sheet-like material 9A as illustrated in FIG. 10 (S2≤T).

From the viewpoint of preventing adhesion of adhesive components to the pair of static elimination rollers 20C when the sheet-like material 9A is applied, it is preferable to set the interval S to the dimension S1 larger than the thickness T of the sheet-like material 9A (S1>T). Even when the dimension S1 is set in this manner, a dimensional relationship of being equal to the thickness T of the sheet-like materials 9A or being equal to or smaller than the thicknesses T may be established due to fluctuations in the thickness T of the sheet-like material 9A.

In addition, the interval S is preferably set to the dimension S2 equal to or smaller than the thickness T of the sheet-like material 9A (S2≤T) from the viewpoint of securing stable static elimination performance.

### (3-3) Operation of Static Elimination Device, Etc.

The static elimination device 1C performs static elimination in the substantially same manner as in the case of the static elimination device 1A according to the first embodiment except for the following differences while transporting the sheet-like material 9A through the transport path 15 so as to pass through the first static elimination unit 2 and the second static elimination unit 3 in this order when the static elimination operation timing arrives and the sheet-like material 9A to be subjected to static elimination is sent into the housing 10.

First, an operation of the static elimination device 1C adopting the pair of static elimination rollers 20C in which the interval S of the void K has the dimension S1 larger than the thickness T of the sheet-like material 9A will be described as illustrated in FIG. 9.

In this case, the first static elimination unit 2 on the static elimination device 1C performs static elimination on the sheet-like material 9A passing in a state of being in non-contact with both the roller bodies 202C of the static elimination rollers 21C and 22C of the pair of static elimination rollers 20C, or in a state of being in non-contact with the roller body 202C of one static elimination roller 21C but being in contact with the roller body 202C of the other static elimination roller 22C.

FIG. 9 illustrates a case in which a surface 9h of the sheet-like material 9A does not come into contact with the roller body 202C of the static elimination roller 21C, and a rear surface 9r of the sheet-like material 9A comes into contact with the roller body 202C of the static elimination roller 22C.

At this time, discharging occurs between the static elimination roller 21C and the sheet-like material 9A in a minute void formed against the sheet-like material 9A in a portion (in, before, and after the void K) where the roller bodies 202C of the static elimination rollers 21C and 22C constituting the pair of static elimination rollers 20C face each other most closely.

Therefore, the sheet-like material 9A is subjected to the static elimination when passing between the pair of static elimination rollers 20C in the first static elimination unit 2 so as to be sandwiched therebetween.

In the static elimination device 1C illustrated in FIG. 9, in a case where static elimination is performed by allowing the sheet-like material 9A having the adhesive layer 93 to pass between the pair of static elimination rollers 20C by the first static elimination unit 2, the sheet-like material 9A passes without coming into contact with one or both of the static elimination rollers 21C and 22C constituting the pair of static elimination rollers 20C.

At this time, as illustrated in FIG. 9, a pressing force F of pressing the passing sheet-like material 9A by the static elimination rollers 21C and 22C becomes zero or substantially zero.

Therefore, even when the pair of static elimination rollers 20C perform the static elimination while passing the sheet-like material 9A, the sheet-like material 9A does not receive a pressure that may cause the adhesive components of the adhesive layer 93 to protrude.

As a result, in the static elimination device 1C illustrated in FIG. 9, the adhesive components of the adhesive layer 93 protruding from both the ends 9e and 9e of the sheet-like material 9A are prevented from adhering to the roller bodies 202C of the static elimination rollers 21C and 22C as compared with a case where the pair of static elimination rollers 20D that come into contact with each other over the entire area in the width direction of the sheet-like material 9A come into contact with each other at a constant contact pressure (refer to FIG. 17).

Next, an operation of the static elimination device 1C adopting the pair of static elimination rollers 20C in which the interval S of the void K has the dimension S2 equal to or smaller than the thickness T of the sheet-like material 9A will be described as illustrated in FIG. 10.

In the first static elimination unit 2 of the static elimination device 1C in this case, static elimination is performed on the sheet-like material 9A passing in a state of being in contact with both of the roller bodies 202C in the static elimination rollers 21C and 22C of the pair of static elimination rollers 20C as illustrated in FIG. 10.

At this time, discharging occurs between the static elimination roller 21C and the sheet-like material 9A in voids formed against the sheet-like material 9A before and after the void K where the roller bodies 202C of the static elimination rollers 21C and 22C face each other most closely.

Therefore, the sheet-like material 9A is subjected to the static elimination when passing between the pair of static elimination rollers 20C of the first static elimination unit 2 so as to be sandwiched therebetween.

In the static elimination device 1C illustrated in FIG. 10, in a case where static elimination is performed by allowing the sheet-like material 9A to pass between the pair of static elimination rollers 20C by the first static elimination unit 2, the sheet-like material 9A passes in the state of being in contact with both the static elimination rollers 21C and 22C constituting the pair of static elimination rollers 20C.

At this time, the static elimination rollers 21C and 22C generate a pressing force F1 having a certain magnitude as the pressing force F of pressing the passing sheet-like material 9A.

On the other hand, as illustrated in FIG. 10, the pressing force F1 at this time is much smaller than the contact pressure P1 generated at the roller bodies 202A in the pair of static elimination rollers 20A in the first embodiment.

Therefore, even in a case where the sheet-like material 9A having the adhesive layer 93 is subjected to the static elimination while passing between the pair of static elimination rollers 20C, the sheet-like material 9A receives a pressure corresponding to the contact pressure P1, but does not receive such a strong pressure that the adhesive components of the adhesive layer 93 protrude.

As a result, in the static elimination device 1C illustrated in FIG. 10, the adhesive components of the adhesive layer 93 protruding from both the ends 9e and 9e of the sheet-like material 9A are prevented from adhering to the roller bodies 202C of the static elimination rollers 21C and 22C as compared with a case where the pair of static elimination rollers 20D that come into contact with each other over the entire area in the width direction of the sheet-like material 9A come into contact with each other at a constant contact pressure (refer to FIG. 17).

### Fourth Embodiment

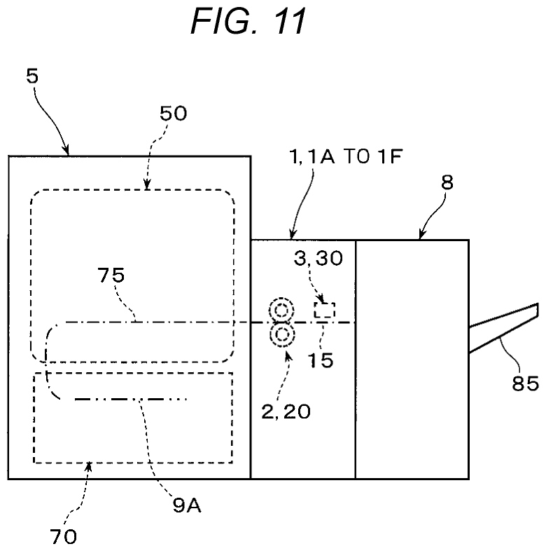

FIG. 11 is a conceptual diagram illustrating a whole of an image forming device 5 including a static elimination device according to a fourth embodiment of the present invention.

### (4-1) Basic Configuration of Image Forming Device

The image forming device 5 includes the image forming section 50 that forms an image on the sheet-like material 9, a static elimination device 1 that performs static elimination on the sheet-like material 9 on which the image has been formed by the image forming section 50, and a post-processing device 8 that performs required post-processing on the sheet-like material 9 that has been subjected to the static elimination by the static elimination device 1.

### (4-2) Basic Configuration of Static Elimination Device

The static elimination device 1 is connected as an external device independent of the image forming device 5 including the image forming section 50.

In addition, the static elimination device 1 is configured using any one of the static elimination devices 1A, 1B, and 1C according to the first to third embodiments (see FIGS. 1A, 1B, 5A, 5B, 8A, 8B, and the like).

### (4-3) Configuration of Image Forming Section

The image forming section 50 is configured as, for example, a device capable of connecting to external equipment such as an information terminal and forming an image corresponding to input image information. The image forming section 50 is configured as an image forming section that utilizes an electrophotographic method.

As illustrated in FIG. 12, the image forming section 50 according to the fourth embodiment includes an image forming unit 51 that forms a toner image, which is an example of an unfixed image, an intermediate transfer unit 60 that relays the toner image formed by the image forming unit 51 to be transferred onto the sheet-like material 9, a fixing unit 68 that fixes the toner image onto the sheet-like material, and a sheet-like material supply unit 70.

The image forming unit 51 is a group of devices configured to form a toner image formed of a toner as a developer based on the image information.

The image forming unit 51 according to the fourth embodiment includes, for example, image forming units 51Y, 51M, 51C, and 51K that individually and exclusively form toner images of yellow (Y), magenta (M), cyan (C), and black (K), respectively.

The image forming units 51Y, 51M, 51C, and 51K (hereinafter, also abbreviated as the image forming units 51 (Y, M, C, K)) have substantially the same configuration except that a color of the developer (the toner in this example) used in a developing device 55 is any one of the above colors abbreviated as Y, M, C, and K and is different from each other.

That is, each of the image forming units 51 (Y, M, C, K) includes a photosensitive drum 52, and equipment such as a charging device 53, an exposure device 54, a developing device 55, a primary transfer device 65, and a drum cleaning device 57 is disposed around the photosensitive drum 52.

As seen from a front surface side of the image forming device 5, the image forming units 51 (Y, M, C, K) are disposed in a state of being arranged in series at predetermined intervals in the left-right direction. The front surface is a surface treated as a surface on the front side of the image forming device 5.

In FIG. 12, references of the photosensitive drum 52, the charging device 53, the exposure device 54, the developing device 55, the primary transfer device 65, and the drum cleaning device 57 are described in the image forming unit 51K. In addition, only the reference of the photosensitive drum 52 is described in the other image forming units 51 (Y, M, C), and the description of the other references is omitted in FIG. 12.

The photosensitive drum 52 is a photosensitive member in a drum form that rotates in a direction indicated by an arrow around a rotation axis (not illustrated) extending along the front-rear direction.

The charging device 53 is a device that charges an outer circumferential surface serving as an image formation surface of the photosensitive drum 52 to a required surface potential. The charging device 53 includes, for example, a charging member such as a charging roller which is brought into contact with an image formation area on the outer circumferential surface of the photosensitive drum 52 and to which a charging current is supplied.

The exposure device 54 is a device that performs exposure based on the image information on the charged outer circumferential surface of the photosensitive drum 52 to form an electrostatic latent image.

The developing device 55 is a device that develops the electrostatic latent image formed on the outer circumferential surface of the photosensitive drum 52 with a developer of a corresponding predetermined color (any color of Y, M, C, and K) to form the toner image, which is an example of the unfixed image.

The primary transfer device 65 is a device that transfers the toner image formed on the outer circumferential surface of each of the photosensitive drums 52 in the image forming units 51 (Y, M, C, K) to an intermediate transfer belt 61 in the intermediate transfer unit 60. The primary transfer device 65 includes a transfer member such as a transfer roller which comes into contact with the outer circumferential surface of the photosensitive drum 52 and to which a primary transfer current is supplied. Note that the primary transfer device 65 is regarded as a component of the intermediate transfer unit 60 in a case where the intermediate transfer unit 60 is adopted.

The drum cleaning device 57 is a device that cleans the outer circumferential surface of the photosensitive drum 52 by removing unnecessary substances such as an unnecessary toner and paper dust adhering to the outer circumferential surface of the photosensitive drum 52.

The intermediate transfer unit 60 is a group of devices configured to transfer the respective toner images formed by the image forming units 51 (Y, M, C, K) to an intermediate transfer body to temporarily hold the toner images, and then, transfer the toner images to the sheet-like material 9.

The intermediate transfer unit 60 includes the intermediate transfer belt 61, which is an example of the intermediate transfer body, support rollers 62 to 64 that rotatably support the intermediate transfer belt 61 from an inner circumferential surface thereof, the primary transfer device 65, a secondary transfer device 66, and a belt cleaning device 67. In addition, the intermediate transfer unit 60 is disposed at a position below the image forming units 51 (Y, M, C, K).

The intermediate transfer belt 61 is an annular belt molded in an annular shape having required width and length, and an outer circumferential surface thereof is a surface capable of holding the toner images by electrostatic action.

The support rollers 62 to 64 support the intermediate transfer belt 61 to be in a substantially inverted triangular form and be rotatable.

The support rollers 62 and 63 support the intermediate transfer belt 61 so as to form a transfer surface that extends in the left-right direction in a planar shape after passing through the photosensitive drums 52 of the image forming units 51 (Y, M, C, K). The support roller 62 is configured as, for example, a driving roller that applies power to rotate the intermediate transfer belt 61 in the direction indicated by the arrow.

The support roller 64 is configured as a secondary transfer back roller that supports the inner circumferential surface of the intermediate transfer belt 61 opposing the secondary transfer device 66.

The primary transfer devices 65 are disposed so as to press the intermediate transfer belt 61 against sites (primary transfer positions) of the respective photosensitive drums 52 of the image forming units 51 (Y, M, C, K) at which primary transfer is performed.

The secondary transfer device 66 is a device that transfers the toner images primarily transferred to the outer circumferential surface of the intermediate transfer belt 61 to the sheet-like material 9. The secondary transfer device 66 includes transfer members such as a transfer roller and a transfer transport belt which come into contact with the outer circumferential surface of the intermediate transfer belt 61 supported by the support roller 64 and to which a secondary transfer current is supplied.

The belt cleaning device 67 is a device that cleans the outer circumferential surface of the intermediate transfer belt 61 by removing unnecessary substances such as an unnecessary toner and paper dust adhering to the outer circumferential surface of the intermediate transfer belt 61.

The fixing unit 68 is a group of devices configured to fix the unfixed toner images, secondarily transferred and held on the sheet-like material 9 by the intermediate transfer unit 60, onto the sheet-like material 9. The fixing unit 68 is disposed, for example, at a position obliquely below one side of the intermediate transfer belt 61 in the intermediate transfer unit 60.

In addition, the fixing unit 68 is configured by disposing equipment such as a rotating member for heating and a rotating member for pressurization in an internal space of a box-shaped housing.

The sheet-like material supply unit 70 is a group of devices configured to store and supply the sheet-like material 9 that needs to be supplied to a site (a secondary transfer position TP) of the intermediate transfer unit 60 where secondary transfer is performed. The sheet-like material supply unit 70 is disposed, for example, at a position below the intermediate transfer unit 60.

In addition, the sheet-like material supply unit 70 includes two containers 71A and 71B that store sheet-like materials 9, and feeding devices 72A and 72B that feed the sheet-like materials 9 one by one from the containers 71A and 71B.

The sheet-like material 9 is a sheet-like material such as a recording sheet or a label sheet which is cut into a predetermined size in advance. The number of the containers 71 is not particularly limited.

In the container 71A, the sheet-like material 9A having the adhesive layer 93 between layers is stored as the sheet-like material 9. In the container 71B, the sheet-like material 9B not having the adhesive layer 93 between layers is stored as the sheet-like material 9.

In the image forming section 50, a transport path 75 is provided to allow the sheet-like materials 9 (9A and 9B) to pass through the fixing unit 68 from the sheet-like material supply unit 70 via the secondary transfer position TP of the intermediate transfer unit 60 and then to be ejected to the outside.

The transport path 75 is configured by disposing a plurality of transport roller pairs 76, a transport belt device 77, a transport guide member (not illustrated), and the like.

### (4-4) Basic Configuration of Post-Processing Device

The post-processing device 8 is a device that performs required post-processing on the sheet-like material 9 on which the image has been formed by the image forming section 50. In the fourth embodiment, the post-processing device 8 is disposed on the downstream side of the static elimination device 1 as illustrated in FIGS. 11 and 12.

The post-processing device 8 is configured to perform at least one of various types of post-processing such as folding processing, cutting processing, binding processing, alignment processing, punching processing, and image inspection processing on the sheet-like material 9. In the post-processing device 8 that performs a plurality of types of post-processing, a transport path (not illustrated) is provided to transport the sheet-like material 9 to locations where the respective types of post-processing are performed in order.

As illustrated in FIG. 11, the post-processing device 8 is provided with, for example, an ejection storage portion 85 including a tray, a stacker, or the like which ejects and stores the sheet-like material 9 after the post-processing.

### (4-5) Operation of Image Forming Device

In the image forming device 5, when a control unit (not illustrated) receives a command for an operation of forming an image from external equipment or the like, a series of basic image forming operations to be described hereinafter is performed in the image forming section 50.

First, in the image forming section 50, a charging operation, an exposure operation, a developing operation, and a cleaning operation are executed in any one of the image forming units 51 (Y, M, C, K), and a primary transfer operation and a secondary transfer operation are executed in the intermediate transfer unit 60 of the image forming section 50. Meanwhile, in the image forming section 50, an operation of supplying the sheet-like material 9 is executed in the sheet-like material supply unit 70 and the transport path 75.

Therefore, after a toner image is formed on the photosensitive drum 52 of any one of the image forming units 51 (Y, M, C, K) in the image forming section 50, the toner image is primarily transferred to the intermediate transfer belt 61 of the intermediate transfer unit 60 mainly by electrostatic action, and then secondarily transferred to the sheet-like material 9 on the intermediate transfer belt 61 mainly by electrostatic action.

Subsequently, in the image forming section 50, the sheet-like material 9 on which the toner image has been secondarily transferred in the intermediate transfer unit 60 is transported to be introduced into the fixing unit 68 by a transport operation of the transport path 75, and a fixing operation is executed in the fixing unit 68.

Therefore, the unfixed toner image is fixed to the sheet-like material 9.

The sheet-like material 9 after completion of the fixing is transported by the transport operation of the transport path 75 and then ejected toward the static elimination device 1 connected to the outside of the image forming section 50.

As described above, a basic image formation operation of forming an image made of a toner on one side of one sheet-like material 9 in the image forming section 50 is completed in the image forming device 5.

In the image formation operation, for example, in a case where an image forming operation is performed in all of the image forming units 51 (Y, M, C, K), a color image which is referred to as a full-color image constituted by toner images of four colors (Y, M, C, K) is formed.

Subsequently, the sheet-like material 9 on which the image has been formed by the image forming section 50 is ejected from the image forming section 50 and is fed to the static elimination device 1.

In the static elimination device 1, the sheet-like material 9 is transported through the transport path 15 so as to pass through the first static elimination unit 2 and the second static elimination unit 3 in this order, and is subjected to a static elimination operation.

Since the static elimination device 1 is configured using any of the static elimination devices 1A, 1B, and 1C according to the first to third embodiments as described above, the static elimination operation is performed in the same manner as described in the first to third embodiments.

Subsequently, the sheet-like material 9 after being subjected to the static elimination by the static elimination device 1 is ejected from the static elimination device 1, and is fed to the post-processing device 8.

Required post-processing is performed in the post-processing device 8.

In addition, in the post-processing device 8, the sheet-like materials 9 after completion of the post-processing are sequentially stored in the ejection storage portion 85 in a stacked state.

Thus, the respective operations by the image forming device 5 end.

Here, in the image forming device 5, a surface of the sheet-like material 9 on which the image has been formed by the image forming section 50 is charged in many cases. For example, the sheet-like material 9 is easily charged when the toner image is secondarily transferred to the sheet-like material 9 mainly by the electrostatic action at the secondary transfer position TP of the intermediate transfer unit 60. In particular, the amount of charge to be charged tends to increase on the sheet-like material 9 containing a high-resistance dielectric such as a synthetic resin. Further, in the sheet-like material 9 whose surface has been charged, charge having an opposite polarity is induced on a rear surface by dielectric polarization.

Then, the sheet-like materials 9 charged in this manner are easily attracted to each other by electrostatic attraction, and a defect such as an overlapping state occurs.

In addition, when the sheet-like materials 9 overlap each other in this manner, it is sometimes difficult to perform normal post-processing in the post-processing device 8. In addition, in a case where the image inspection processing is performed as the post-processing in the post-processing device 8, noise is sometimes generated when the inspection such as reading of the image or inspection of the surface potential is performed in the image inspection processing so that it is not possible to obtain a normal inspection result.

In this regard, the static elimination device 1 is disposed on the downstream side of the image forming section 50 and on the upstream side of the post-processing device 8 in the image forming device 5, and thus, the sheet-like material 9 on which the image has been formed by the image forming section 50 can be fed to the post-processing device 8 after the static elimination is performed by the static elimination device 1.

Therefore, the occurrence of the defect caused by the presence of unnecessary charge on the sheet-like material 9 is finally avoided according to the image forming device 5.

In addition, even in a case where the sheet-like material 9A having the adhesive layer 93 between layers is applied as the sheet-like material 9 in the image forming device 5, adhesive components of the adhesive layer 93 protruding from both ends of the sheet-like material 9A are prevented from adhering to the pair of static elimination rollers 20 in the first static elimination unit 2 of the static elimination device 1 as described in the first to third embodiments.

Therefore, even in a case where the sheet-like material 9A is adopted in the image forming device 5, it is possible to avoid the occurrence of a decrease in static elimination performance due to the adhesion of the adhesive components to the pair of static elimination rollers 20 in the static elimination device 1.

### (4-6) Modification of Image Forming Section

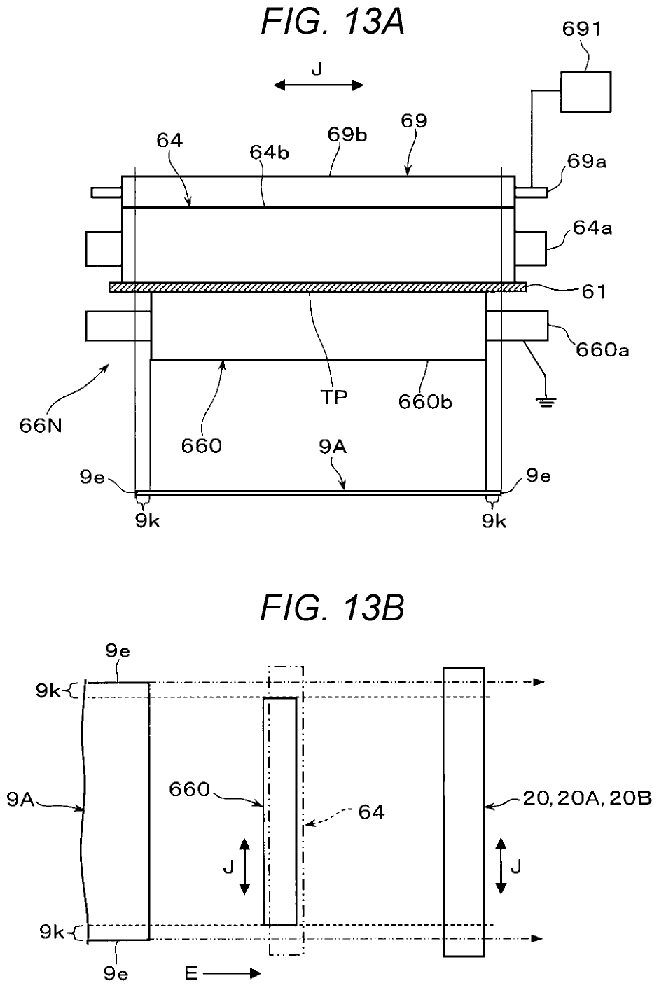

As the secondary transfer device 66 of the intermediate transfer unit 60 in the image forming section 50, a secondary transfer device 66N according to a modification in which a part of the configuration is different may be adopted as illustrated in FIGS. 13A and 13B.

As illustrated in FIGS. 13A and 13B, a secondary transfer roller 660 whose length in the axial direction J is short so as to prevent contact and passage of left and right ends 9k and 9k of the sheet-like material 9A during transport is applied in the secondary transfer device 66N according to the modification.

The ends 9k and 9k of the sheet-like material 9A are portions on which no image is formed in the image forming section 50 or portions to be finally cut off (for example, by the cutting processing in the post-processing device 8).

The secondary transfer roller 660 includes a shaft 660a and a roller body 660b provided on the outer circumference of the shaft 660a.

In the secondary transfer device 66N according to the modification, a length of the roller body 660b of the secondary transfer roller 660 is set to a short dimension as described above. However, the length of the roller body 660b needs to be set to such a length that an image formation area (an area secured to allow transfer of a toner image that is to form an image) can be secured.

In addition, the secondary transfer device 66N according to the modification is configured such that a secondary transfer current is supplied from a power supply device 691 to the support roller 64 serving as the secondary transfer back roller that supports the intermediate transfer belt 61 via a power supply roller 69 as illustrated in FIGS. 13A and 13B.

The support roller 64 includes a shaft 64a and a roller body 64b. The power supply roller 69 includes a shaft 69a and a roller body 69b.

When the secondary transfer device 66N according to this modification is adopted, a secondary transfer operation is performed without causing the ends 9k and 9k of the sheet-like material 9A to be in contact with the secondary transfer roller 660 in the secondary transfer of the sheet-like material 9A as illustrated in FIG. 13B. Therefore, the ends 9k and 9k of the sheet-like material 9A are not directly affected by a transfer electric field generated by the secondary transfer current via the support roller 64 and the intermediate transfer belt 61, and are hardly charged.

As a result, the image forming device 5 adopting the secondary transfer device 66N according to modification suppresses not only charging of the ends 9k and 9k of the sheet-like material 9A in a step of secondarily transferring a toner image but also insufficient static elimination on the ends 9k and 9k of the sheet-like material 9A in the static elimination device 1 as compared with a case where a transfer roller that comes into contact with the entire area in the width direction of the sheet-like material 9A is adopted as the transfer roller of the secondary transfer device 66 of the image forming section 50.

This is particularly effective in a case where the static elimination device 1A or 1B according to the first or second embodiment (the device including the pair of static elimination rollers 20A or 20B in the first static elimination unit 2) is adopted as the static elimination device 1.

### Fifth Embodiment

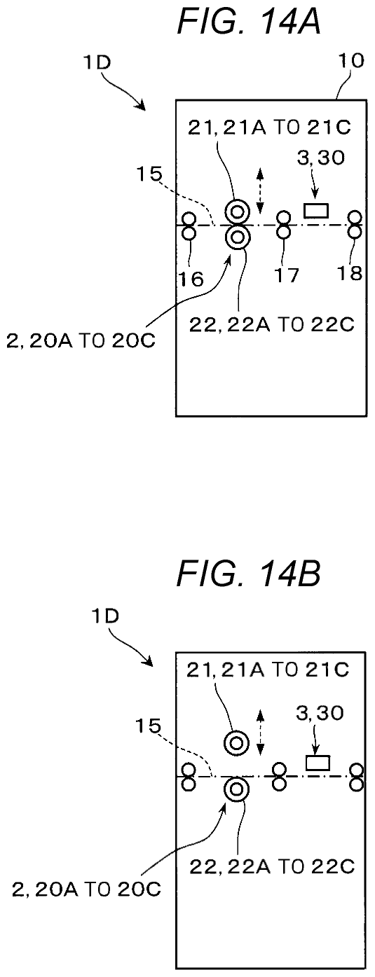

FIGS. 14A and 14B are conceptual diagrams illustrating a whole of a static elimination device 1D according to a fifth embodiment of the present invention.

The static elimination device 1D has a configuration in which one static elimination roller 21A, 21B, or 21C constituting the pair of static elimination rollers 20A, 20B, or 20C of the first static elimination unit 2 according to any of the first to third embodiments is brought into contact with and apart from the other static elimination roller 22A, 22B, or 22C.

An operation of bringing one static elimination roller 21A, 21B, or 21C into contact and apart is performed by, for example, a mechanism that moves or swings a member such as a frame that supports each of the shafts 201.

For example, when the sheet-like material 9A having the adhesive layer 93 between layers is applied as the sheet-like material 9, the static elimination device 1D moves the one static elimination roller 21A, 21B, or 21C so as to come into contact with the other static elimination roller 22A, 22B, or 22C as illustrated in FIG. 14A.

Therefore, in a case where static elimination is performed while allowing the sheet-like material 9A to pass between the pair of static elimination rollers 20A, 20B, or 20C in the first static elimination unit 2, as described in the first to third embodiments, it is possible to prevent adhesive components of the adhesive layer 93 protruding from both the ends 9e, 9e of the sheet-like material 9A from adhering to the pair of static elimination rollers 20A, 20B, or 20C in the static elimination device 1D.

As illustrated in FIG. 14B, the static elimination device 1D moves the one static elimination roller 21A, 21B, or 21C to be apart from the other static elimination roller 22A, 22B, or 22C by a predetermined distance when the sheet-like material 9A that does not require static elimination or the sheet-like material 9B that does not have the adhesive layer 93 between layers and does not require static elimination is applied as the sheet-like material 9. At this time, a voltage for static elimination is not supplied to any of the static elimination roller 21A, 21B, or 21C and the non-contact static eliminator 30 of the second static elimination unit 3.

Therefore, in the static elimination device 1D, the sheet-like materials 9A and 9B which do not require the static elimination as described above can be allowed to pass through the transport path 15 and transported to the post-processing device 8 or the like on the downstream side without being subjected to the static elimination by the first static elimination unit 2 and the second static elimination unit 3.

In addition, in a case where the pair of static elimination rollers 20A or 20B of the first static elimination unit 2 according to the first or second embodiment is applied in the static elimination device 1D, one static elimination roller 21A or 21B is moved to be in contact with the other static elimination roller 22A or 22B when a static elimination operation by the static elimination device 1D is performed. On the other hand, when the static elimination operation by the static elimination device 1D is not performed, the one static elimination roller 21A or 21B is moved to be apart from the other static elimination roller 22A or 22B.

In the static elimination device 1D in this case, it is possible to prevent the possibility of occurrence of unnecessary deformation (distortion) between the one static elimination roller 21A or 21B and the other static elimination roller 22A or 22B due to continuous contact between the one static elimination roller 21A or 21B and the other static elimination roller 22A or 22B at the required contact pressure P1 when static elimination by the pair of static elimination rollers 20A or 20B is unnecessary.

### Sixth Embodiment

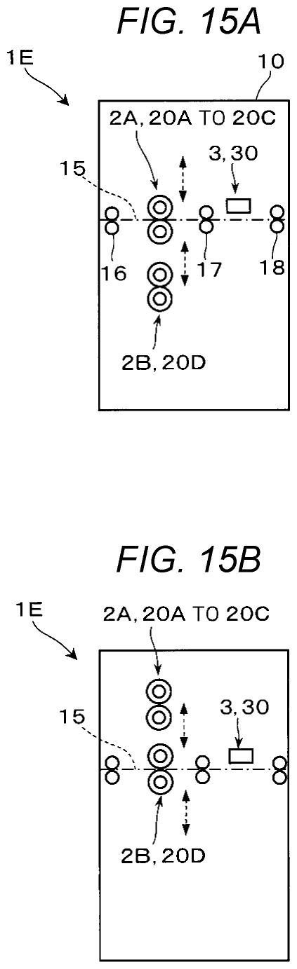

FIGS. 15A and 15B are conceptual diagrams illustrating a whole of a static elimination device 1E according to a sixth embodiment of the present invention.

The static elimination device 1E includes, as the first static elimination unit 2, a first static elimination unit 2A to which any one of the pair of static elimination rollers 20A, 20B, and 20C according to the first to third embodiments is applied, and a first static elimination unit 2B to which the pair of static elimination rollers 20D is applied.

The pair of static elimination rollers 20D in the first static elimination unit 2B is a pair of static elimination rollers (see FIG. 17) including the static elimination rollers 21D and 22D which come into contact with each other at the required contact pressure P1 over the entire area in the width direction of the sheet-like material 9A.

In addition, the static elimination device 1E is configured to move the pair of static elimination rollers 20A, 20B, or 20C of the first static elimination unit 2A and the pair of static elimination rollers 20D of the first static elimination unit 2B between an operation position of operating in the transport path 15 and a retracted position of being retracted from the transport path 15.

For example, when the sheet-like material 9A having the adhesive layer 93 between layers is applied as the sheet-like material 9, the static elimination device 1E moves the pair of static elimination rollers 20A, 20B, or 20C of the first static elimination unit 2A to the operation position, and moves the pair of static elimination rollers 20D of the first static elimination unit 2B to the retracted position as illustrated in FIG. 15A.

Therefore, in the static elimination device 1E, the first static elimination unit 2A performs an operation of performing static elimination while allowing the sheet-like material 9A to pass between the pair of static elimination rollers 20A, 20B, or 20C. At this time, in the static elimination device 1E, the adhesive components of the adhesive layer 93 protruding from both the ends 9e and 9e of the sheet-like material 9A are prevented from adhering to the pair of static elimination rollers and 20A, 20B, or 20C as described in the first to third embodiments.

In addition, for example, when the sheet-like material 9B that does not have the adhesive layer 93 is applied as the sheet-like material 9, the static elimination device 1E moves the pair of static elimination rollers 20A, 20B, or 20C in the first static elimination unit 2A to the retracted position, and moves the pair of static elimination rollers 20D in the first static elimination unit 2B to the operation position as illustrated in FIG. 15B.

Therefore, in the static elimination device 1E, the static elimination is performed with the pair of static elimination rollers 20D being in contact with the entire area of the sheet-like material 9B in the first static elimination unit 2B, and as a result, substantially uniform static elimination can be performed on the entire area of the sheet-like material 9B. By the way, in the first static elimination unit 2B, there is no possibility of adhesion of the adhesive components as in the case where the sheet-like material 9A is applied since the sheet-like material 9B does not have the adhesive layer 93.

### Seventh Embodiment

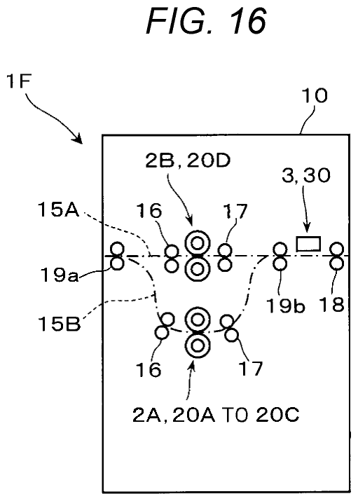

FIG. 16 is a conceptual diagram illustrating a whole of a static elimination device 1F according to a seventh embodiment of the present invention.

The static elimination device 1F has the same configuration as that of the static elimination device 1E according to the fifth embodiment except for a change to a configuration to be described hereinafter.

That is, the static elimination device 1F is provided with a first transport path 15A for transporting the sheet-like material 9 so as to pass between the pair of static elimination rollers 20D of the first static elimination unit 2B in the static elimination device 1E, and a second transport path 15B for transporting the sheet-like material 9 so as to pass between the pair of static elimination rollers 20A, 20B, or 20C of the first static elimination unit 2A in the static elimination device 1E.

In the static elimination device 1F illustrated in FIG. 16, the first transport path 15A is formed as a transport path extending substantially horizontally, and the pair of static elimination rollers 20D of the first static elimination unit 2B is disposed in the middle of the first transport path 15A.

In addition, in the static elimination device 1F, the second transport path 15B is formed as a transport path that branches off from a starting end of the first transport path 15A, extends so as to bend to the lower side, then extends so as to bend to the upper side, passes through the first static elimination unit 2B of the first transport path 15A, and joins the first transport path 15A at a portion in front of the second static elimination unit 3. In addition, (any one of) the pair of static elimination rollers 20A, 20B, and 20C of the first static elimination unit 2A is disposed in the middle of the second transport path 15B bending to the lower side and extending. A transport roller pair 19a that transports the introduced sheet-like material 9 is disposed on the upstream side of a branching position.

Further, in the static elimination device 1F, a route switching unit (not illustrated) that switches a route in which the sheet-like material 9 proceeds is disposed at a position of the first transport path 15A from which the second transport path 15B branches off and a joining position of the second transport path 15B. A transport roller pair 19b that transports the sheet-like material 9 to the second static elimination unit 3 is disposed on the downstream side of the joining position.

When the sheet-like material 9B that does not have the adhesive layer 93 is applied as the sheet-like material 9, the static elimination device 1F feeds the sheet-like material 9B into the first transport path 15A, and transports the sheet-like material 9B so as to pass through one static elimination roller 20D in the first static elimination unit 2B in the middle of the first transport path 15A.

Therefore, in the static elimination device 1F, static elimination is performed with the pair of static elimination rollers 20D being in contact with the entire area of the sheet-like material 9B in the first static elimination unit 2B, and as a result, substantially uniform static elimination can be performed on the entire area of the sheet-like material 9B.

In addition, when the sheet-like material 9A having the adhesive layer 93 between layers is applied as the sheet-like material 9, the static elimination device 1F feeds the sheet-like material 9A to the second transport path 15B and transports the sheet-like material 9A so as to pass through one static elimination roller 20A, 20B, or 20C in the first static elimination unit 2A in the middle of the second transport path 15B.

Therefore, in the static elimination device 1F, static elimination is performed by any one of the pair of static elimination rollers 20A, 20B, and 20C in the first static elimination unit 2A, and as a result, adhesive components of the adhesive layer 93 protruding from both the ends 9e and 9e of the sheet-like material 9A are prevented from adhering to the pair of static elimination rollers 20A, 20B, or 20C.

### Modifications.

The present invention is not limited to the configurations exemplified as the first to seventh embodiments described above, and various modifications and alterations can be made within a scope not departing from a gist of each invention described in the claims. Thus, the present invention encompasses, for example, the following modifications.

The static elimination devices 1A, 1B, 1C, 1D, 1E, and 1F according to the first to third and fifth to seventh embodiments may have a configuration in which the second static elimination unit 3 is omitted and only the first static elimination unit 2 is provided. The same applies to the static elimination device 1 in the image forming device 5 according to the fourth embodiment.

A static elimination device including only the first static elimination unit 2 is effective, for example, in a case where it is sufficient to perform at least static elimination of the sheet-like material 9, or in a case where it is desired to preferentially prevent the adhesion of the adhesive components of the adhesive layer 93 in a case where the sheet-like material 9A is applied as the sheet-like material 9.

Although a configuration example in which the static elimination device 1 is combined as an external independent connection device has been described as the image forming device 5 in the fourth embodiment, the image forming device 5 may have a configuration in which the static elimination device 1 is combined as an internal device disposed inside.

In this case, the static elimination device 1 as the internal device may be disposed, for example, at a position on the downstream side of the fixing unit 68 in the image forming section 50. In addition, in a case where it is desired to perform static elimination of the sheet-like material 9 before an image is formed by the image forming section 50, the static elimination device 1 as the internal device may be disposed at a position between the sheet-like material supply unit 70 and the secondary transfer position TP of the intermediate transfer unit 60 in the image forming section 50.

In the fourth embodiment, a configuration example in which the image forming section 50 utilizes the electrophotographic method has been described as the image forming device 5, but the image forming section may utilize other image forming methods as long as an image can be formed on the sheet-like material 9. Examples of the other image forming methods include an ink droplet jetting method and a thermal transfer method.

### (Supplementary Notes)

(((1)

A static elimination device comprising: a pair of static elimination rollers that performs static elimination by allowing passage of a sheet-like material to be sandwiched between the pair of static elimination rollers; and a power supply unit that supplies a voltage for static elimination to at least one static elimination roller of the pair of static elimination rollers, the pair of static elimination rollers being a pair of static elimination rollers in which contact pressures at ends in an axial direction are lower than a contact pressure at a portion other than the ends.

(((2)))

A static elimination device comprising: a pair of static elimination rollers that performs static elimination by allowing passage of a sheet-like material to be sandwiched between the pair of static elimination rollers; and a power supply unit that supplies a voltage for static elimination to at least one static elimination roller of the pair of static elimination rollers, the pair of static elimination rollers being a pair of static elimination rollers that does not come into contact with ends in a width direction of the sheet-like material.

(((3)))

A static elimination device comprising: a pair of static elimination rollers that performs static elimination by allowing passage of a sheet-like material to be sandwiched between the pair of static elimination rollers, the pair of static elimination rollers being a pair of static elimination rollers disposed in a non-contact state in which both the static elimination rollers do not come into contact with each other; a power supply unit that supplies a voltage for static elimination to at least one static elimination roller of the pair of static elimination rollers; and an upstream transport roller pair and a downstream transport roller pair that are disposed on an upstream side and a downstream side of the pair of static elimination rollers disposed in the non-contact state in a direction in which the sheet-like material passes, and transport the sheet-like material to pass between the pair of static elimination rollers.

(((4)))

The static elimination device according to (((1))), in which the pair of static elimination rollers having the lower contact pressures at the ends is configured as rollers having shapes in which outer diameters of the ends in the axial direction of at least one static elimination roller are smaller than an outer diameter of the portion other than the ends.

(((5)))

The static elimination device according to (((1))), further comprising an upstream transport roller pair and a downstream transport roller pair that are disposed on an upstream side and a downstream side of the pair of static elimination rollers having the lower contact pressures at the ends in a direction in which the sheet-like material passes, and transport the sheet-like material to pass between the pair of static elimination rollers, in which the contact pressures in the entire area in the axial direction of the pair of static elimination rollers having the lower contact pressures at the ends are lower than a contact pressure of the upstream transport roller pair.

(((6))

The static elimination device according to (((2))), in which the pair of static elimination rollers that does not come into contact with both the ends of the sheet-like material are configured as rollers each having a length in an axial direction shorter than a width of the sheet-like material during transport.

(((7)))

The static elimination device according to (((2))), further comprising an upstream transport roller pair and a downstream transport roller pair that are disposed on an upstream side and a downstream side of the pair of static elimination rollers that does not come into contact with both the ends of the sheet-like material in a direction in which the sheet-like material passes, and transport the sheet-like material to pass between the pair of static elimination rollers, in which a contact pressure in the entire area in an axial direction of the pair of static elimination rollers that does not come into contact with both the ends of the sheet-like material is lower than a contact pressure of the upstream transport roller pair.

(((8)))

The static elimination device according to (((3))), in which the pair of static elimination rollers disposed in the non-contact state is maintained in the non-contact state by a void holding member that holds a void between both the static elimination rollers.

(((9))

The static elimination device according to (((4))), in which the pair of static elimination rollers having the lower contact pressures at the ends have a constant outer diameter in the portion other than the ends.

(((10)))

The static elimination device according to (((6))), in which the pair of static elimination rollers that does not come into contact with both the ends of the sheet-like material is configured as rollers in which small-diameter end roller members each having a relatively small outer diameter are disposed at both ends of both the static elimination rollers in an axial direction.

(((11))

The static elimination device according to (((8))), in which the pair of static elimination rollers disposed in the non-contact state is held with the void in which the sheet-like material does not come into contact with at least one static elimination roller.

(((12)))

The static elimination device according to (((8))), in which the pair of static elimination rollers disposed in the non-contact state is held with the void in which the passing sheet-like material comes into contact with both the static elimination rollers.

(((13)))

The static elimination device according to (((1))), in which the power supply unit supplies power by constant voltage control.

(((14)))

A static elimination device configured using the static elimination device according to any one of (((1))) to ((13))), the static elimination device comprising: a first static elimination unit including a pair of static elimination rollers that performs static elimination by allowing passage of the sheet-like material to be sandwiched between the pair of static elimination rollers; and a second static elimination unit that performs static elimination in a non-contact state on the sheet-like material on which the static elimination has been performed by the first static elimination unit.

(((15)))

The static elimination device according to any one of (((1))) to (((13))), in which a sheet-like material that is a sheet having a multilayer structure and includes an adhesive layer between layers is allowed to pass as the sheet-like material.

(((16)))

The static elimination device according to (((14))), in which a sheet-like material that is a sheet having a multilayer structure and includes an adhesive layer between layers is allowed to pass as the sheet-like material.

(((17)))

An image forming device comprising: an image forming section that forms an image on a sheet-like material; and a static elimination device that performs static elimination on the sheet-like material on which the image has been formed by the image forming section, the static elimination device being configured using the static elimination device according to any one of (((1))) to (((13))).

(((18)))

An image forming device comprising: an image forming section that forms an image on a sheet-like material; and a static elimination device that performs static elimination on the sheet-like material on which the image has been formed by the image forming section, the static elimination device being configured using the static elimination device according to (((14))).

(((19)))

The image forming device according to (((17))), in which a sheet-like material that is a sheet having a multilayer structure and includes an adhesive layer between layers is allowed to pass as the sheet-like material.

(((20)))

The image forming device according to (((18))), in which a sheet-like material that is a sheet having a multilayer structure and includes an adhesive layer between layers is allowed to pass as the sheet-like material.

What is claimed is:

1. A static elimination device comprising:
a pair of static elimination rollers that performs static elimination by allowing passage of a sheet-like material to be sandwiched between the pair of static elimination rollers; and
a power supply unit that supplies a voltage for static elimination to at least one static elimination roller of the pair of static elimination rollers,
wherein the pair of static elimination rollers is a pair of static elimination rollers in which contact pressures at ends in an axial direction are lower than a contact pressure at a portion other than the ends.

2. A static elimination device comprising:
a pair of static elimination rollers that performs static elimination by allowing passage of a sheet-like material to be sandwiched between the pair of static elimination rollers; and
a power supply unit that supplies a voltage for static elimination to at least one static elimination roller of the pair of static elimination rollers,
wherein the pair of static elimination rollers is a pair of static elimination rollers that does not come into contact with ends in a width direction of the sheet-like material.

3. A static elimination device comprising:
a pair of static elimination rollers that performs static elimination by allowing passage of a sheet-like material to be sandwiched between the pair of static elimination rollers; and
a power supplying unit that supplies a voltage for static elimination to at least one static elimination roller of the pair of static elimination rollers,
wherein,
as the pair of static elimination rollers, the pair of static elimination rollers disposed in a non-contact state in which the two static elimination rollers are not in contact with each other are provided, and an upstream side transport roller pair and a downstream side transport roller pair that are disposed on an upstream side and a downstream side of the pair of static elimination rollers disposed in the non-contact state in a direction in which the sheet-like material passes and transport the sheet-like material so as to pass the pair of static elimination rollers are provided.

4. The static elimination device according to claim 1, wherein
the pair of static elimination rollers having the lower contact pressures at the ends is configured as rollers having shapes in which outer diameters of the ends in the axial direction of at least one static elimination roller are smaller than an outer diameter of a portion other than the ends.

5. The static elimination device according to claim 1, further comprising
an upstream transport roller pair and a downstream transport roller pair that are disposed on an upstream side and a downstream side of the pair of static elimination rollers having the lower contact pressures at the ends in a direction in which the sheet-like material passes, and transport the sheet-like material so as to pass the pair of static elimination rollers,
wherein the contact pressures in an entire area in the axial direction of the pair of static elimination rollers having the lower contact pressures at the ends are lower than a contact pressure of the upstream transport roller pair.

6. The static elimination device according to claim 2, wherein
the pair of static elimination rollers that does not come into contact with both the ends of the sheet-like material are configured as rollers each having a length in an axial direction shorter than a width of the sheet-like material during transport.

7. The static elimination device according to claim 2, further comprising:
a pair of upstream transport rollers and a pair of downstream transport rollers that are disposed on an upstream side and a downstream side of a pair of static elimination rollers not in contact with both ends of the sheet-like material in a direction in which the sheet-like material passes and transport the sheet-like material so as to pass the pair of static elimination rollers,
wherein
a contact pressure in an entire region in an axial direction of the pair of static elimination rollers not in contact with both ends of the sheet-like material is lower than a contact pressure of the pair of upstream transport rollers.

8. The static elimination device according to claim 3, wherein
the pair of static elimination rollers disposed in the non-contact state is maintained in the non-contact state by a void holding member that holds a void between both the static elimination rollers.

9. The static elimination device according to claim 4, wherein
the pair of static elimination rollers having the lower contact pressures at the ends have a constant outer diameter in the portion other than the ends.

10. The static elimination device according to claim 6, wherein
the pair of static elimination rollers that does not come into contact with both the ends of the sheet-like material is configured as rollers in which small-diameter end roller members each having a relatively small outer diameter are disposed at both ends of both the static elimination rollers in an axial direction.

11. The static elimination device according to claim 8, wherein
the pair of static elimination rollers disposed in the non-contact state is held with the void in which the sheet-like material does not come into contact with at least one static elimination roller.

12. The static elimination device according to claim 8, wherein
the pair of static elimination rollers disposed in the non-contact state is held with the void in which the passing sheet-like material comes into contact with both the static elimination rollers.

13. The static elimination device according to claim 1, wherein
the power supply unit supplies power by constant voltage control.

14. A static elimination device configured using the static elimination device according to claim 1, the static elimination device comprising:
a first static elimination unit including a pair of static elimination rollers that performs static elimination by allowing passage of the sheet-like material to be sandwiched between the pair of static elimination rollers; and
a second static elimination unit that performs static elimination in a non-contact state on the sheet-like material on which the static elimination has been performed by the first static elimination unit.

15. The static elimination device according to claim 1, wherein
a sheet-like material that is a sheet having a multilayer structure and includes an adhesive layer between layers is allowed to pass as the sheet-like material.

16. The static elimination device according to claim 14, wherein
a sheet-like material that is a sheet having a multilayer structure and includes an adhesive layer between layers is allowed to pass as the sheet-like material.

17. An image forming device comprising:
an image forming section that forms an image on a sheet-like material; and
a static elimination device that performs static elimination on the sheet-like material on which the image has been formed by the image forming section,
wherein the static elimination device is configured using the static elimination device according to claim 1.

18. An image forming device comprising:
an image forming section that forms an image on a sheet-like material; and
a static elimination device that performs static elimination on the sheet-like material on which the image has been formed by the image forming section,
wherein the static elimination device is configured using the static elimination device according to claim 14.

19. The image forming device according to claim 17, wherein
a sheet-like material that is a sheet having a multilayer structure and includes an adhesive layer between layers is allowed to pass as the sheet-like material.

20. The image forming device according to claim 18, wherein
a sheet-like material that is a sheet having a multilayer structure and includes an adhesive layer between layers is allowed to pass as the sheet-like material.
